(19) United States
(12) Patent Application Publication
(10) Pub. No.: US 2025/0285113 A1
(43) Pub. Date: Sep. 11, 2025

(54) DATA TRACKER

(71) Applicant: Visa International Service Association, San Francisco, CA (US)

(72) Inventors: Manav Shah, Walkeshwar (IN); Alok Roy, Bengaluru (IN); Prajna Shetty, Padubidri (IN); Debdeep Bandyopadhyay, Durgapur (IN); Prithwish Banerjee, Bangalore (IN); Shivam Mohan, Lucknow (IN); Ravi Shanker Kumar Sinha, Bangalore (IN)

(73) Assignee: Visa International Service Association, San Francisco, CA (US)

(21) Appl. No.: 18/596,724

(22) Filed: Mar. 6, 2024

(51) Int. Cl. G06Q 20/40; G06Q 20/36

(52) U.S. Cl. CPC G06Q 20/4014; G06Q 20/367; G06Q 2220/00

(57) ABSTRACT

Ethical data tracker systems and methods are disclosed. A payment network computer receives a token request from an application running on a client device. The token request includes user contact information and a merchant identifier. A token server computer generates a token associated with the merchant identifier. The payment network computer maps the token to the user contact information and the merchant identifier, stores the token, the user contact information, and the merchant identifier in a database, and determines a validation of a mapping in the database of a token and a merchant identifier received from a network service provider. The payment network computer authorizes or prohibits the network service provider to communicate with the account holder via the user contact information based on the determining of the validation of the mapping in the database of the token and the merchant identifier received from the network service provider.

### TECHNICAL FIELD

The present disclosure is generally directed to tokenization. More particularly, the present disclosure is directed to preventing personal data breaches during a transaction.

### SUMMARY

In one aspect, the present disclosure provides a computer-implemented method, comprising: receiving, by a payment network computer, a token request from an application running on a client device, wherein the token request comprises user contact information and a merchant identifier; generating, by a token server computer, a token associated with the merchant identifier; mapping, by the payment network computer, the token to the user contact information and the merchant identifier; storing, by the payment network computer, the token, the user contact information, and the merchant identifier in a database; determining, by the payment network computer, a validation of a mapping in the database of a token and a merchant identifier received from a network service provider; and authorizing or prohibiting, by the payment network computer, the network service provider to communicate with the account holder via the user contact information based on the determining of the validation of the mapping in the database of the token and the merchant identifier received from the network service provider.

In another aspect, the present disclosure provides a computer-implemented method, comprising: receiving, by a payment network computer, a token request from a mobile application running on a client device, wherein the token request is associated with user contact information and a merchant identifier; generating, by a token server computer, a token based on the token request; mapping, by the payment network computer, the token to the user contact information and the merchant identifier; storing, by the payment network computer, the token, the user contact information, and the merchant identifier in a payment network computer database; and sending, by the payment network computer, the token to the client device to initiate a transaction with the merchant and enable the merchant to send information to the client device using the token and the merchant identifier.

In another aspect, the present disclosure provides A data tracker system, comprising: a payment network computer comprising a processor and a memory; a token server computer comprising a processor and memory; a database coupled to the payment network computer, the database storing a mapping of a token, a merchant identifier, and user contact information; wherein the memory of the token server computer stores machine executable instructions that when executed cause the token server computer processor to generate a token associated with a merchant identifier; and wherein the memory of the payment network computer stores machine executable instructions that when executed cause the payment network computer processor to: receive a request for a token associated with the merchant identifier from a client device; map the token, the merchant identifier, and the user contact information; and store the mapping of the token, the merchant identifier, and the user contact information; and determine a validity of the mapping of a token and a merchant identifier received form a network service provider.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The system and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates a data tracker system, according to an aspect of this disclosure.

FIG. 2 illustrates a method for provisioning a token in the data tracker system described in reference to FIG. 1, according to an aspect of this disclosure.

FIG. 3 illustrates a method of a successful merchant to user communication using a token in the data tracker system described in reference to FIG. 1, according to an aspect of this disclosure.

FIG. 4 illustrates a method of a failed third party merchant to user communication using a token in the data tracker system described in reference to FIG. 1, according to an aspect of this disclosure.

FIG. 5 shows a block diagram of a payment network computer, according to at least one aspect of the present disclosure.

FIG. 6 illustrates a block diagram of a tokenization environment portion of a token management system, according to at least one aspect of the present disclosure.

FIG. 7 illustrates a block diagram of a communication device that may be used in aspects, according to at least one aspect of the present disclosure.

FIG. 8 is a block diagram of a computer apparatus with data processing subsystems or components, according to at least one aspect of the present disclosure.

FIG. 9 is a diagrammatic representation of an example system that includes a host machine within which a set of instructions to perform any one or more of the methodologies discussed herein may be executed, according to at least one aspect of the present disclosure.

FIG. 10 illustrates a computer-implemented method, according to an aspect of this disclosure.

FIG. 11 illustrates a computer-implemented method, according to an aspect of this disclosure.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific embodiments, aspects, or examples, some descriptions of terms used herein are provided below.

An “acceptance device” may be any suitable device that can accept or initiate a transaction. Non-limiting examples of an acceptance device may include a point-of-sale system, cash register, transaction processing computer, an authentication computer, a computing device, or a merchant server, such as a web server or e-commerce payment gateway configured to receive payment or transaction information. An acceptance device may further contain at least one processor, memory, secure element, speaker, display, wireless radio, card reader, or any other suitable component, or any combination thereof.

An “access device” may be any suitable device that provides access to a remote system. An access device may also be used for communicating with a merchant computer, a transaction processing computer, an authentication computer, or any other suitable system. An access device may generally be located in any suitable location, such as at the location of a merchant. An access device may be in any suitable form. Some examples of access devices include POS or point-of-sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, and the like. An access device may use any suitable contact or contactless mode of operation to send or receive data from, or associated with, a user mobile device. In some embodiments or aspects, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a payment device and/or mobile device. In a further example, communication may occur between a contactless element of a portable communication device and an access device, such as a merchant device reader or point-of-sale terminal, by using a wireless communications mechanism, such as near field communications (NFC), RF, infra-red, optical communications, etc. In some embodiments or aspects, a cellular phone, tablet, or other dedicated wireless device used as a POS terminal may be referred to as a mobile point-of-sale or an “mPOS” terminal.

“Account credentials” may include any information that identifies an account and allows a payment processor to verify that a device, person, or entity has permission to access the account. For example, account credentials may include an account identifier (e.g., a PAN), a token (e.g., account identifier substitute), an expiration date, a cryptogram, a verification value (e.g., card verification value (CVV)), personal information associated with an account (e.g., address, etc.), an account alias, or any combination thereof. Account credentials may be static or dynamic such that they change over time. Further, in some embodiments or aspects, the account credentials may include information that is both static and dynamic. For example, an account identifier and expiration date may be static but a cryptogram may be dynamic and change for each transaction. Further, in some embodiments or aspects, some or all of the account credentials may be stored in a secure memory of a user device. The secure memory of the user device may be configured such that the data stored in the secure memory may not be directly accessible by outside applications and a payment application associated with the secure memory may be accessed to obtain the credentials stored on the secure memory. Accordingly, a mobile application may interface with a payment application in order to gain access to payment credentials stored on the secure memory.

An “account credential,” “account number,” or “payment credential” may refer to any suitable information associated with an account (e.g., a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. Payment credentials may be any information that identifies or is associated with a payment account. Payment credentials may be provided in order to make a payment from a payment account. Payment credentials can also include a user name, an expiration date, a gift card number or code, and any other suitable information.

“Account data,” as used herein, refers to any data concerning one or more accounts for one or more users. Account data may include, for example, one or more account identifiers, user identifiers, transaction histories, balances, credit limits, issuer institution identifiers, and/or the like.

An “account identifier” may refer to one or more types of identifiers associated with an account (e.g., a unique identifier of an account, an account number, a PAN, a card number, a payment card number, a token, and/or the like) of a user. In some non-limiting embodiments or aspects, an issuer may provide an account identifier (e.g., a PAN, a token, a globally unique identifier (GUID), a universally unique identifier (UUID), and/or the like) to a user that uniquely identifies one or more accounts associated with that user. In some non-limiting embodiments or aspects, an account identifier may be embodied on a payment device (e.g., a portable financial instrument, a payment card, a credit card, a debit card, and/or the like) and/or may be electronic information communicated to the user that the user may use for electronic payment transactions. In some non-limiting embodiments or aspects, an account identifier may be an original account identifier, where the original account identifier was provided to a user at the creation of the account associated with the account identifier. In some non-limiting embodiments or aspects, the account identifier may be an account identifier (e.g., a supplemental account identifier) that is provided to a user after the original account identifier was provided to the user. For example, if the original account identifier is forgotten by the user, stolen from the user, and/or the like, a supplemental account identifier may be provided to the user. In some non-limiting embodiments or aspects, an account identifier may be directly or indirectly associated with an issuer such that an account identifier may be a token that maps to a PAN or other type of identifier. Account identifiers may be alphanumeric, any combination of characters and/or symbols, and/or the like.

An “account token” may refer to an identifier that is used as a substitute or replacement identifier for an account identifier, such as a PAN. An account token may be used as a substitute or replacement identifier for an original account identifier, such as a PAN. Account tokens may be associated with a PAN or other original account identifier in one or more data structures (e.g., one or more databases and/or the like) such that they may be used to conduct a transaction without directly using the original account identifier. In some non-limiting embodiments or aspects, an original account identifier, such as a PAN, may be associated with a plurality of account tokens for different individuals or purposes. In some non-limiting embodiments' aspects, account tokens may be associated with a PAN or other account identifiers in one or more data structures such that they can be used to conduct a transaction without directly using the account identifier, such as a PAN. In some examples, an account identifier, such as a PAN, may be associated with a plurality of account tokens for different uses or different purposes.

An “application” may include any software module configured to perform a specific function or functions when executed by a processor of a computer. For example, a “mobile application” may include a software module that is configured to be operated by a mobile device. Applications may be configured to perform many different functions. For instance, a “payment application” may include a software module that is configured to store and provide account credentials for a transaction. A “wallet application” may include a software module with similar functionality to a payment application that has multiple accounts provisioned or enrolled such that they are usable through the wallet application. Further, an “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

A “client” and “client device” may refer to one or more client-side devices or systems (e.g., remote from a transaction service provider) used to initiate or facilitate a transaction (e.g., a payment transaction). Moreover, a “client” may also refer to an entity (e.g., a merchant, an acquirer, and/or the like) that owns, utilizes, and/or operates a client device for initiating transactions (e.g., for initiating transactions with a transaction service provider). A “client device” and “user device” may refer to any electronic device that is configured to communicate with one or more servers or remote devices and/or systems. A client device or a user device may include a mobile device, a network-enabled appliance (e.g., a network-enabled television, refrigerator, thermostat, and/or the like), a computer, a POS system, and/or any other device or system capable of communicating with a network. A client device may further include a desktop computer, laptop computer, mobile computer (e.g., smartphone), a wearable computer (e.g., a watch, pair of glasses, lens, clothing, and/or the like), a cellular phone, a network-enabled appliance (e.g., a network-enabled television, refrigerator, thermostat, and/or the like), a point-of-sale (POS) system, and/or any other device, system, and/or software application configured to communicate with a remote device or system.

“Communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting embodiments or aspects, a message may refer to a packet (e.g., a data packet, a network packet, and/or the like) that includes data. It will be appreciated that numerous other arrangements are possible.

A “communication channel” may refer to any suitable path for communication between two or more entities. Suitable communications channels may be present directly between two entities such as a payment processing network and a merchant or issuer computer, or may include a number of different entities. Any suitable communications protocols may be used for generating a communications channel. A communication channel may in some instances comprise a “secure communication channel” or a “tunnel,” either of which may be established in any known manner, including the use of mutual authentication and a session key and establishment of a secure communications session. However, any method of creating a secure communication channel may be used, and communication channels may be wired or wireless, as well as long-range, short-range, or medium-range. By establishing a secure channel, sensitive information related to a payment device (such as account number, CVV values, expiration dates, etc.) may be securely transmitted between the two entities to facilitate a transaction

A “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

A “consumer” may include an individual or a user that may be associated with one or more personal accounts and/or consumer devices. The consumer may also be referred to as a cardholder, account holder, or user.

“Contact information” comprises client device identification, email address, street address, and/or Internet Protocol (IP) address.

A “credential” may be any suitable information that serves as reliable evidence of worth, ownership, identity, or authority. A credential may be a string of numbers, letters, or any other suitable characters that may be present or contained in any object or document that can serve as confirmation. Examples of credentials include value credentials, identification cards, certified documents, access cards, passcodes and other login information, etc.

A “device,” “server,” “processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

A “digital wallet” can include an electronic device that allows an individual to conduct electronic commerce transactions. A digital wallet may be designed to streamline the purchase and payment process. A digital wallet may allow the user to load one or more payment cards onto the digital wallet so as to make a payment without having to enter an account number or present a physical card.

A “digital wallet provider” may include an entity, such as an issuing bank or third party service provider, that issues a digital wallet to a user that enables the user to conduct financial transactions. A digital wallet provider may provide standalone user-facing software applications that store account numbers, or representations of the account numbers (e.g., payment tokens), on behalf of a cardholder (or other user) to facilitate payments at more than one unrelated merchant, perform person-to-person payments, or load financial value into the digital wallet. A digital wallet provider may enable a user to access its account via a personal computer, mobile device or access device. Additionally, a digital wallet provider may also provide one or more of the following functions: storing multiple payment cards and other payment products on behalf of a user, storing other information including billing address, shipping addresses, and transaction history, initiating a transaction by one or more methods, such as providing a user name and password, NFC or a physical token, and may facilitate pass-through or two-step transactions.

An “electronic wallet,” “digital wallet” or “mobile wallet” can store user profile information, payment information (including tokens), bank account information, and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like.

An “electronic wallet,” “electronic wallet mobile application,” and “digital wallet” may refer to one or more electronic devices and/or one or more software applications configured to initiate and/or conduct transactions (e.g., payment transactions, electronic payment transactions, and/or the like). For example, an electronic wallet may include a user device (e.g., a mobile device) executing an application program and server-side software and/or databases for maintaining and providing transaction data to the user device.

An “electronic wallet provider” may include an entity that provides and/or maintains an electronic wallet and/or an electronic wallet mobile application for a user (e.g., a customer). Examples of an electronic wallet provider include, but are not limited to, Google Wallet™, Android Pay®, Apple Pay®, and Samsung Pay®, and/or other like electronic payment systems. In some non-limiting examples, a financial institution (e.g., an issuer institution) may be an electronic wallet provider. As used herein, the term “electronic wallet provider system” may refer to one or more computer systems, computer devices, servers, groups of servers, and/or the like operated by or on behalf of an electronic wallet provider.

An “electronic wallet transaction processing system” may refer to one or more electronic devices and/or software applications configured to process and/or a request to authenticate a user for a transaction initiated and/or conducted by an electronic wallet application. For example, an electronic wallet transaction processing system may include server-side software and/or databases for maintaining and providing transaction data and/or account data to a merchant system and/or a payment gateway system for processing and/or authenticating a user for an electronic wallet transaction. An “electronic wallet transaction processing system provider” may include an entity that provides and/or maintains an electronic wallet transaction processing system, such as Visa Checkout, Mastercard MasterPass™, PayPal Checkout, and/or other like electronic wallet transaction processing system providers. In some non-limiting examples, a transaction service provider system may be an electronic wallet transaction processing system.

An “end-user” may include any application, consumer, process, or system that is configured to interact with a requestor for tokenization/de-tokenization/token management services. For example, an end-user may include a consumer, a merchant, a mobile device, or any other suitable entity that may be associated with a requestor in the network token system.

An “identification and verification (ID&V) method” may be used to ensure that the payment token is replacing a PAN that was legitimately being used by the token requestor. Examples of ID&V methods may include, but are not limited to, an account verification message, a risk score based on assessment of the primary account number (PAN) and use of one time password by the issuer or its agent to verify the account holder. Exemplary ID&V methods may be performed using information such as a user signature, a password, an offline or online personal identification number (PIN), an offline or online enciphered PIN, a combination of offline PIN and signature, a combination of offline enciphered PIN and signature, user biometrics (e.g., voice recognition, fingerprint matching, etc.), a pattern, a glyph, knowledge-based challenge responses, hardware tokens (multiple solution options), one time passwords (OTPs) with limited use, software tokens, two-channel authentication processes (e.g., via phone), etc. Using the ID&V, a confidence level may be established with respect to the token to PAN binding.

“Identification information” may include any suitable information associated with an account (e.g., a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors).

An “interface” may include any software module configured to process communications. For example, an interface may be configured to receive, process, and respond to a particular entity in a particular communication format. Further, a computer, device, and/or system may include any number of interfaces depending on the functionality and capabilities of the computer, device, and/or system. In some embodiments or aspects, an interface may include an application programming interface (API) or other communication format or protocol that may be provided to third parties or to a particular entity to allow for communication with a device. Additionally, an interface may be designed based on functionality, a designated entity configured to communicate with, or any other variable. For example, an interface may be configured to allow for a system to field a particular request or may be configured to allow a particular entity to communicate with the system.

An “issuer” can include a payment account issuer. The payment account (which may be associated with one or more payment devices) may refer to any suitable payment account (e.g., credit card account, a checking account, a savings account, a merchant account assigned to a consumer, or a prepaid account), an employment account, an identification account, an enrollment account (e.g., a student account), etc.

An “issuer institution,” “portable financial device issuer,” “issuer,” or “issuer bank” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions), such as initiating credit and/or debit payments. For example, an issuer may provide an account identifier, such as a personal account number (PAN), to a user that uniquely identifies one or more accounts associated with the user. The account identifier may be used by the user to conduct a payment transaction. The account identifier may be embodied on a portable financial device, such as a physical financial instrument, e.g., a payment card, and/or may be electronic and used for electronic payments. In some non-limiting embodiments or aspects, an issuer may be associated with a bank identification number (BIN) that uniquely identifies the issuer. As used herein “issuer system” or “issuer institution system” may refer to one or more systems operated by or operated on behalf of an issuer. For example, an issuer system may refer to a server executing one or more software applications associated with the issuer. In some non-limiting embodiments or aspects, an issuer system may include one or more servers (e.g., one or more authorization servers) for authorizing a payment transaction.

A “key” may refer to a piece of information that is used in a cryptographic algorithm to transform input data into another representation. An exemplary encryption key may include a master derivation key (MDK) which may be used to generate a limited use key (LUK) that is provided to a computer device of a user. An LUK can be an encryption key that is intended for limited use (e.g., a limited number of transactions or a limited time period) and is not intended to be used for the lifetime of an account. Further details regarding LUKs can be found in U.S. Published Patent Application No. 2015/0180836, which is herein incorporated by reference in its entirety and is assigned to the same assignee as the present application. The MDK may be used to generate and provision the token, as well as, authenticate the token when used in authorization processing by validating static and variable transaction data.

A “merchant” may refer to one or more individuals or entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein “merchant system” may refer to one or more computer systems operated by or on behalf of a merchant, such as a server computer executing one or more software applications.

A “merchant application” may include any application associated with a relying party to a transaction. For example, a merchant mobile application may be associated with a particular merchant or may be associated with a number of different merchants. In some embodiments or aspects, the merchant mobile application may store information identifying a particular merchant server computer that is configured to provide a sales environment in which the merchant server computer is capable of processing remote transactions initiated by the merchant application. Further, the merchant mobile application may also include a general purpose browser or other software designed to interact with one or more merchant server computers. In some cases, the merchant mobile application may be installed in the general purpose memory of a user device and thus, may be susceptible to malicious attacks.

A “merchant category code” (MCC) may refer to a numerical indication of a type of business classified according to the goods or services the business provides, such as “supermarket,” “quick service restaurant,” or “fuel dispenser.” Different rates may be charged by a payment processing network depending on the MCC generating the transaction. A user may generate transactions having different associated MCC values and may wish to generate different routing priority lists for each MCC. A merchant verification value (MVV) may be a customizable value, such as a numerical indication of a region or a particular store.

A “mobile device” may comprise any electronic device that may be transported and operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of mobile devices include mobile phones (e.g., cellular phones), PDAs, tablet computers, net books, laptop computers, personal music players, hand-held specialized readers, etc. Further examples of mobile devices include wearable devices, such as smart watches, fitness bands, ankle bracelets, rings, earrings, etc., as well as automobiles with remote communication capabilities. A mobile device may comprise any suitable hardware and software for performing such functions, and may also include multiple devices or components (e.g., when a device has remote access to a network by tethering to another device—e.g., using the other device as a modem—both devices taken together may be considered a single mobile device). A mobile device may also comprise a verification token in the form of, for instance, a secured hardware or software component within the mobile device and/or one or more external components that may be coupled to the mobile device. A detailed description of an exemplary mobile device is provided below.

A “multimedia object” may refer to a digital file containing multimedia content including audio, images, animations, video, vibration patterns, and interactive content. Multimedia objects may be represented in various formats and computer file types or may be represented by a pointer, network address, or uniform resource indicator (URI) denoting a location at which a multimedia file may be located and/or retrieved. Multimedia objects may be output by a computing device with suitable output capability and may be observable by a device user or other entity.

A “network service provider” comprises any entity that provides a network, storage or processing service such as, for example, telephone companies, mobile network service providers, Internet service providers (ISP), application service providers (ASP), storage service providers (SSP), and content providers (digital service provider and cable TV).

An “online purchase” can be the purchase of a digital or physical item or service via a network, such as the Internet.

An “original” transaction may include any transaction including an authorization provided by an issuer or an authorization provided on-behalf-of an issuer.

A “payment account” (which may be associated with one or more payment devices) may refer to any suitable payment account including a credit card account, a checking account, or a prepaid account.

A “payment application” or “wallet application” may store credentials (e.g., account identifier, expiration date, card verification value (CVV), etc.) for accounts provisioned onto the user device. The account credentials may be stored in general memory on the mobile device or on a secure trusted execution environment (e.g., a secure element) of the user device. Further, in some embodiments or aspects, the account credentials may be stored by a remote computer and the payment/wallet application may retrieve the credentials (or a portion thereof) from the remote computer before/during a transaction. Any number of different commands or communication protocols may be used to interface with the payment application and/or wallet application in order to obtain and use stored credentials associated with each application.

The payment application or wallet application may be configured to provide credentials to an authorized software application or module on a user device. For example, a payment application may be configured to interface with a master applet in order to provide credentials to a mobile application for a transaction. For instance, the payment application may provide a software development kit (SDK) or application programming interface (API) that the master wallet applet may use to interface with the payment application and/or wallet application. The payment application and/or wallet application may be configured to provide the sensitive information in encrypted form using stored encryption keys. Thus, each payment application and/or wallet application may have different commands and/or instructions for accessing the associated credentials stored by the payment/wallet application. For instance, each payment application and/or wallet application may have a different application program interface (API) with different commands, data requirements, authentication processes, etc., for interacting with other applications operating on the user device. Accordingly, a master wallet applet may include a number of different APIs, one for each of the different payment applications and/or wallet applications that the master wallet applet is configured to interface with.

A “payment device” may refer to any device that may be used to conduct a financial transaction, such as to provide payment information to a merchant. A payment device may be in any suitable form. The payment device may be a software object, a hardware object, or a physical object. As examples of physical objects, the payment device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device. For example, suitable payment devices can be hand-held and compact so that they can fit into a consumer's wallet and/or pocket (e.g., pocket-sized). They may include smart cards, debit devices (e.g., a debit card), credit devices (e.g., a credit card), stored value devices (e.g., a stored value card or “prepaid” card), magnetic stripe cards, keychain devices (such as the Speedpass™ commercially available from Exxon-Mobil Corp.), etc. Other examples of payment devices include cellular or wireless telephones (e.g., a smartphone), personal digital assistants (PDAs), portable computer (e.g., tablet or laptop computer), pagers, payment cards, security cards, access cards, smart media, transponders, 2-D barcodes, an electronic or digital wallet, and the like. If the payment device is in the form of a debit, credit, or smartcard, the payment device may also optionally have features such as magnetic stripes. Such devices can operate in either a contact or contactless mode. In some non-limiting embodiments or aspects, a payment device may include an electronic payment device, such as a smartcard, a chip card, integrated circuit card, and/or the like. An electronic payment device may include an embedded integrated circuit and the embedded integrated circuit may include a data storage medium (e.g., volatile and/or non-volatile memory) to store information associated with the payment device, such as an account identifier, a name of the account holder, and/or the like. The payment device may interface with an access device such as a point-of-sale device to initiate the transaction. In some embodiments or aspects, a mobile device can function as a payment device (e.g., a mobile device can store and be able to transmit payment credentials for a transaction). Further, a payment device may be associated with a value such as a monetary value, a discount, or store credit, and a payment device may be associated with an entity such as a bank, a merchant, a payment processing network, or a person. A payment device may be used to make a payment transaction.

A “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway and/or to a payment gateway itself. The term “payment gateway mobile application” may refer to one or more electronic devices and/or one or more software applications configured to provide payment services for transactions (e.g., payment transactions, electronic payment transactions, and/or the like).

A “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

A “payment processing network” may refer to a system that receives accumulated transaction information from the gateway processing service, typically at a fixed time each day, and performs a settlement process. Settlement may involve posting the transactions to the accounts associated with the payment devices used for the transactions and calculating the net debit or credit position of each user of the payment devices. An exemplary payment processing network is Interlink®.

A “payment token issuer identifier” may include any series of characters, numbers, or other identifiers that may be used to identify an issuer associated with a payment token. For example, a payment token issuer identifier may include a token BIN that identifies a particular issuer associated with an account identified using the token. In some embodiments or aspects, a payment token issuer identifier may be mapped to a real issuer identifier (e.g., a BIN) for an issuer. For example, a payment token issuer identifier may include a six digit numerical value that may be associated with an issuer. For instance, any token including the payment token issuer identifier may be associated with a particular issuer. As such, the issuer may be identified using the corresponding issuer identifier range associated with the token issuer identifier. For example, a payment token issuer identifier “490000” corresponding to a payment token “4900 0000 0000 0001” can be mapped to an issuer identifier “414709” corresponding to a payment account identifier “4147 0900 0000 1234.” In some embodiments or aspects, a payment token issuer identifier is static for an issuer. For example, a payment token issuer identifier (e.g., “490000”) may correspond to a first issuer and another payment token issuer identifier (e.g., “520000”) may correspond to a second issuer, and the first and second payment token issuer identifiers may not be changed or altered without informing all entities within the network token processing system. In some embodiments or aspects, a payment token issuer identifier range may correspond to an issuer identifier. For example, payment tokens including payment token issuer identifiers from “490000”-“490002” may correspond to a first issuer (e.g., mapped to issuer identifier “414709”) and payment tokens including payment token issuer identifiers from “520000”-“520002” may correspond to a second issuer (e.g., mapped to real issuer identifier “417548”).

A “point-of-sale system,” “POS system,” or “POS terminal,” as used herein, may refer to one or more computers and/or peripheral devices used by a merchant to engage in payment transactions with customers, including one or more card readers, near-field communication (NFC) receivers, radio-frequency identification (RFID) receivers, and/or other contactless transceivers or receivers, contact-based receivers, payment terminals, computers, servers, input devices, and/or other like devices that can be used to initiate a payment transaction. A POS terminal may be located proximal to a user, such as at a physical store location, or a POS terminal may be remote from the user, such as a server interacting with a user browsing on their personal computer. POS terminals may include mobile devices.

A “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments or aspects, the portable financial device may include volatile or non-volatile memory to store information (e.g., an account identifier, a name of the account holder, and/or the like).

A “primary account number (PAN)” may be a variable length, (e.g., 13 to 19-digit) industry standard-compliant account number that is generated within account ranges associated with a BIN by an issuer.

A “processing network” may include an electronic system used to accept, transmit, or process transactions made by devices. The processing network may transfer information among transacting parties (e.g., issuers, acquirers, merchants, device users, etc.).

As used herein, the term “product” may refer to one or more goods and/or services offered by a merchant.

“Provisioning” may include a process of providing data for use. For example, provisioning may include providing, delivering, or enabling a token on a device. Provisioning may be completed by any entity within or external to the transaction processing system. For example, in some embodiments or aspects, tokens may be provisioned by an issuer or a payment processing network onto a mobile device of a consumer (e.g., account holder). The provisioned tokens may have corresponding token data stored and maintained in the token vault or token registry. In some embodiments or aspects, a token vault or token registry may generate a token that may then be provisioned or delivered to a device. In some embodiments or aspects, an issuer may specify a token range from which token generation and provisioning can occur. Further, in some embodiments or aspects, an issuer may generate and notify a token vault of a token value and provide the token record information (e.g., token attributes) for storage in the token vault.

A “requestor” may be an entity that can request an item or action. A requestor may be an application, a device, or a system that is configured to perform actions associated with tokens. For example, a requestor can request registration with a network token system, request token generation, token activation, token de-activation, token exchange, other token life-cycle management related processes, and/or any other token related processes. A requestor may interface with a network token system through any suitable communication networks and/or protocols (e.g., using HTTPS, simple object access protocol (SOAP) and/or an extensible markup language (XML) interface). Some non-limiting examples of a requestor may include third party wallet providers, issuers, acquirers, merchants, and/or payment processing networks.

A requestor may be referred to as a “token requestor” when requesting generation of a new token or requesting a new use of an existing token from a network token system. In some embodiments or aspects, a token requestor can request tokens for multiple domains and/or channels. Some non-limiting examples of token requestors may include, for example, card-on-file merchants, acquirers, acquirer processors, and payment gateways acting on behalf of merchants, payment enablers (e.g., original equipment manufacturers, mobile network operators, etc.), digital wallet providers, issuers, third party wallet providers, and/or payment processing networks. A token requestor may refer to an entity that is seeking to implement tokenization according to embodiments or aspects of the present disclosure. The token requestor may initiate a request that a primary account number (PAN) be tokenized by submitting a token request message to the token service provider. According to various embodiments or aspects discussed herein, a token requestor may no longer need to store a PAN associated with a token once the requestor have received the token in response to a token request message. A token requestor may be registered and identified uniquely by the token service provider within the tokenization ecosystem. During token requestor registration, the token service provider may formally process token requestor's application to participate in the token service system. The token service provider may collect information pertaining to the nature of the requestor and relevant use of tokens to validate and formally approve the token requestor and establish appropriate domain restriction controls. Successfully registered token requestors may be assigned a token requestor identifier that may also be entered and maintained within the token vault. Token requestors be revoked or assigned new token requestor identifiers. This information may be subject to reporting and audit by the token service provider.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

As used herein, the term “system” may refer to one or more computing devices or combinations of computing devices (e.g., processors, servers, client devices, software applications, components of such, and/or the like).

A “token” or “payment token” may include an identifier for a payment account that is a substitute for an account identifier, such as a primary account number (PAN). For example, a token may include a series of numeric and/or alphanumeric characters that may be used as a substitute for an original account identifier. For example, a token “4900 0000 0000 0001” may be used in place of a PAN “4147 0900 0000 1234.” In some embodiments or aspects, a token may be “format preserving” and may have a numeric format that conforms to the account identifiers used in existing payment processing networks (e.g., ISO 8583 financial transaction message format). In some embodiments or aspects, a token may be used in place of a PAN to initiate, authorize, settle or resolve a payment transaction or represent the original credential in other systems where the original credential would typically be provided. In some embodiments or aspects, a token value may be generated such that the recovery of the original PAN or other account identifier from the token value may not be computationally derived. For example, a token may have a random association with a particular real PAN so that the real PAN is not computationally derivable from the token. A lookup table may be used to associate a real PAN and a corresponding random token. Further, in some embodiments or aspects, the token format may be configured to allow the entity receiving the token to identify it as a token and recognize the entity that issued the token.

According to various embodiments or aspects, a token may be associated with a token status. The token status may indicate, for example, that the token is a high quality token or a low quality token. The status of the token may be indicative of a level of restriction associated with the token. For example, no restrictions may be imposed on a high quality token whereas restrictions such as further identification requirements may be imposed on a low quality token. The status of the token may be based at least in part on the confidence level with which the token is generated.

In some embodiments or aspects, tokens may be device-specific such that each device associated with an account may be provisioned with a particular token. As such, if a transaction uses a token that is initiated by a different device than the device that the token was provisioned into, the transaction may be fraudulent. Accordingly, device information may be stored in the token vault and used to ensure that the device used in a transaction is associated with the token that is being used in the transaction. Additionally, because each token may be associated with a single device, one PAN or account may have multiple tokens associated with it, where each PAN may have a different token for the different devices that may be used to initiate a transaction associated with the PAN using a specific token. This provides additional security for transactions because network token systems have additional information to validate in order to control the use of sensitive information in a transaction processing system.A number of tokens can include a number of dynamic tokens that can be requested for the same account identifier (e.g., PAN) and/or same device at one time. In some embodiments or aspects, the number of tokens can be optionally provided to the token requestor at the time of a token generation request. In some embodiments or aspects, tokens may be provided with overlapping time to live (TTL) so that one or more tokens may be active at any given time.

In some embodiments or aspects, the token format may allow entities in the payment system to identify the issuer associated with the token. For example, the format of the token may include a token issuer identifier that allows an entity (e.g., the payment processing network) to identify an issuer of the token. For instance, the token issuer identifier may be associated with an issuer's BIN of the underlying PAN in order to support the existing payment flow. The token issuer identifier may be a different number than the issuer's BIN and may be static. For example, if the issuer's BIN for an issuer is 412345, the token issuer identifier may be a token BIN of 428325 and this number may be static for all tokens issued from or for that issuer. In some embodiments or aspects, the token issuer identifier range (e.g., issuer token BIN range) may have the same attributes as the associated issuer card range and can be included in an issuer identifier routing table (e.g., BIN routing table). The issuer identifier routing table may be provided to the relevant entities in the payment system (e.g., merchants and acquirers).

“Tokenization” is a process by which data is replaced with substitute data. For example, a payment account identifier (e.g., a primary account number (PAN)) may be tokenized by replacing the primary account identifier with a substitute number (e.g., a token) that may be associated with the payment account identifier. Further, tokenization may be applied to any other-information which may be replaced with a substitute value (e.g., token, a credit card verification value (CVV)). Tokenization may be used to enhance transaction efficiency, improve transaction security, increase service transparency, or to provide a method for third party enablement.

“Token attributes” may include any feature or information about a token. For example, token attributes may include information that can determine how a token can be used, delivered, issued, or otherwise how data may be manipulated within a transaction system. For example, token attributes may determine how a token may be used in place of a real account identifier (e.g., PAN) for a transaction. For example, the token attributes may include a type of token, frequency of use, token expiry date and/or expiry time, a number of associated tokens, a transaction lifecycle expiry date, and any additional information that may be relevant to any entity within a tokenization ecosystem. For example, token attributes may include a wallet identifier associated with the token, an additional account alias or other user account identifier (e.g., an email address, username, etc.), a device identifier, an invoice number, etc. In some embodiments or aspects, a token requestor may provide token attributes at the time of requesting the generation of tokens. In some embodiments or aspects, a network token system, payment network associated with the network token system, an issuer, or any other entity associated with the token may determine and/or provide the token attributes associated with a particular token.

The token attributes may identify a type of token indicating how to use the token. For example, a type of token may be “payment” or “non-payment” to identify the token as being a payment token or a non-payment token. A payment token may include a high value token that can be used in place of a real account identifier (e.g., PAN) to generate original and/or subsequent transactions for a consumer account and/or card.

Another token type may be a “static” or “dynamic” token type for static and dynamic tokens, respectively. For example, a static token may include a token that may be issued by a payment processing network or issuer that may be issued in place of an account identifier (e.g., PAN) and may be used for the duration of the underlying account identifier (e.g., PAN). As such, static tokens may be used to submit any number of transactions and may not change for each transaction. Static tokens may be securely stored on the consumer device (e.g., stored in a secure memory or secure element of a mobile device) or in the cloud by the token requestor and may be delivered securely to a mobile device. However, static tokens may include sensitive information that may be protected as they may be used to perform multiple transactions over long periods of time.

Alternatively, dynamic tokens can include tokens that are limited or restricted in use (e.g., limited by time, amount threshold (aggregated amount or single-transaction amount), or by number of uses). As such, dynamic tokens can be generated and delivered on a per-transaction or on an as needed basis to the end user to initiate a payment transaction through a registered and authenticated device and/or channel. For example, a one-time use dynamic token can be used at electronic-commerce (e-commerce) websites and if the dynamic token is intercepted by a third party, the dynamic token may be useless because it has been used and is thus worthless for future transactions.

Non-payment tokens may include tokens which are not substitutes for real account identifiers (e.g., PANs). For example, non-payment tokens may be used by merchant/acquirer systems for analytics, offers, customer support, marketing, etc. However, non-payment tokens may not be used to generate original and subsequent transactions using real account identifiers (e.g., PANs) or other account identifiers. Accordingly, non-payment tokens may include low value tokens that may be used for non-payment transactions or transaction services by an entity within the transaction processing system.

A “token issuer identifier range (issuer BIN range)” may refer to a unique identifier (e.g., of 6 to 12 digits length) originating from a set of pre-allocated token issuer identifiers (e.g., 6 digit token BINs). For example, in some embodiments or aspects, one or more token BIN ranges can be allocated to each issuer BIN range that is associated with an issuer. In some embodiments or aspects, the token BIN ranges may be used to generate a payment token and may not be used to generate a non-payment token. As such, the non-payment tokens may comprise different token issuer identifiers or may not comprise token issuer identifiers. In some embodiments or aspects, a token may pass the basic validation rules of an account number including, for example, a LUHN check or checksum validation that may be set up by different entities within the payment system. In some embodiments or aspects, a payment token issuer identifier may be mapped to a real issuer identifier (e.g., a BIN) for an issuer. For example, a payment token issuer identifier may include a six digit numerical value that may be associated with an issuer. For instance, any token including the payment token issuer identifier may be associated with a particular issuer. As such, the issuer may be identified using the corresponding issuer identifier range associated with the token issuer identifier. For example, a payment token issuer identifier “540000” corresponding to a payment token “5400 0000 0000 0001” can be mapped to an issuer identifier “553141” corresponding to a payment account identifier “553141 0900 0000 1234”. In some embodiments or aspects, a payment token issuer identifier is static for an issuer. For example, a payment token issuer identifier (e.g., “540000”) may correspond to a first issuer and another payment token issuer identifier (e.g., “550000”) may correspond to a second issuer, and the first and second payment token issuer identifiers may not be changed or altered without informing all entities within the network token processing system. In some embodiments or aspects, a payment token issuer identifier range may correspond to an issuer identifier. For example, payment tokens including payment token issuer identifiers from “490000”-“490002” may correspond to a first issuer (e.g., mapped to issuer identifier “414709”) and payment tokens including payment token issuer identifiers from “520000”-“520002” may correspond to a second issuer (e.g., mapped to real issuer identifier “517548”). Token BIN Ranges and assignment of tokens from these BIN ranges may be made available to the parties accepting the transaction to make routing decisions.

A “token presentment mode” may indicate a method through which a token is submitted for a transaction. Some non-limiting examples of the token presentment mode may include machine readable codes (e.g., quick response code (QRC), barcode, etc.), mobile contactless modes (e.g., near-field communication (NFC) communication), e-commerce remote modes, e-commerce proximity modes, and any other suitable modes in which to submit a token. Tokens may be provided through any number of different methods. For example, in one implementation, a token may be embedded in machine-readable code which may be generated by a wallet provider, mobile application, or other application on mobile device and displayed on a display of the mobile device. The machine readable code can be scanned at the POS through which the token is passed to the merchant. A mobile contactless mode may include passing the token through NFC in a contactless message. An e-commerce remote mode may include submitting a token by a consumer or a wallet provider through an online transaction or as an e-commerce transaction using a merchant application or other mobile application. An e-commerce proximity mode may include submitting a token by a consumer from a wallet application on a mobile device at a merchant location.

The token presentment mode may include any identifier or method for indicating the mode through which a token is provided. For example, the token presentment mode may include a number associated with a particular type of transaction (e.g., 5 for NFC transaction, 3 for QR Code, etc.). Further, in some embodiments or aspects, the token presentment mode could be provided through a type of cryptogram or other dynamic data generated for a transaction. For example, each type of transaction presentment mode may have a different cryptogram algorithm associated with that type of presentment mode (e.g., NFC vs. QR Code), and the type of cryptogram used by be determined during validation of the cryptogram. Additionally, a token presentment mode may be provided by a mobile device or may be populated by a merchant access device (e.g., a POS terminal) or other entity within the transaction processing system (e.g., acquirer computer, merchant processor, etc.).

“Token Processing” may refer to transaction processing in which a token is present in lieu of the primary account number (PAN). The token is processed from the point of interaction throughout the network. The token processing further includes using the token vault for de-tokenization of the token in order to complete the transaction. Token processing may span payment processes that include authorization, capture, clearing, and exception processing.

A “token request message” may be an electronic message for requesting a token. A token request message may include information usable for identifying a payment account or digital wallet, and/or information for generating a payment token. For example, a token request message may include payment credentials, mobile device identification information (e.g., a phone number or MSISDN), a digital wallet identifier, information identifying a tokenization service provider, a merchant identifier, a cryptogram, and/or any other suitable information. Information included in a token request message can be encrypted (e.g., with an issuer-specific key). In some embodiments or aspects, a token request message may be formatted as an authorization request message (e.g., an ISO 8583 message format). In some embodiments or aspects, the token request message may have a zero dollar amount in an authorization amount field. As another example, the token request message may include a flag or other indicator specifying that the message is a token request message.

A “token request indicator” may refer to an indicator used to indicate that the message containing the indicator is related to a token request. The token request indicator may optionally be passed to the issuer as part of the Identification and Verification (ID&V) method to inform the issuer of the reason the account status check is being performed.

A “token requestor identifier (ID)” may include any characters, numerals, or other identifiers associated with an entity associated with a network token system. For example, a token requestor identifier may be associated with an entity that is registered with the network token system. In some embodiments or aspects, a unique token requestor ID may be assigned for each domain for a token request associated with the same token requestor. As such, in some embodiments or aspects, if a token requestor may request tokens for multiple domains, the token requestor may have multiple token requestor identifiers, one for each domain. For example, a token requestor ID can identify a pairing of a token requestor (e.g., a mobile device, a mobile wallet provider, etc.) with a token domain (e.g., e-commerce, contactless, etc.). A token requestor ID may include any format or type of information. For example, in one embodiment or aspect, the token requestor ID may include an alphanumerical value such as a ten digit or an eleven digit letter and/or number (e.g., 4678012345). In some embodiments or aspects, a token requestor ID may include a code for a token service provider (e.g., first 3 digits) such as the network token system and the remaining digits may be assigned by the token service provider for each requesting entity (e.g., mobile wallet provider) and the token domain (e.g., contactless, e-commerce, etc.).

In some embodiments or aspects, a token requestor identifier may be used in a transaction during authorization processing. For example, a token requestor identifier may be passed through a transaction request message to validate that the entity that is initiating the transaction is the same as the entity that requested and manages the token. In some embodiments or aspects, an entity (e.g., digital or mobile wallet provider, merchant, merchant of record, payment enabler, etc.) can be assigned a token requestor identifier during an on-boarding or registration process. In some embodiments or aspects, an acquirer/acquirer processor/payment enabler (e.g., payment service provider) may populate the token requestor identifier for each merchant, mobile wallet provider, consumer, etc. into the authorization message field prior to submitting the authorization request message to a payment processing network.

A “token response message” may be a message that responds to a token request. A token response message may include an indication that a token request was approved or denied. A token response message may also include a payment token, mobile device identification information (e.g., a phone number or MSISDN), a digital wallet identifier, information identifying a tokenization service provider, a merchant identifier, a cryptogram, and/or any other suitable information. Information included in a token response message can be encrypted (e.g., with an issuer-specific key). In some embodiments or aspects, a token response message may be formatted as an authorization response message (e.g., an ISO 8583 message format). In some embodiments or aspects, the token response message may have a zero dollar amount in an authorization amount field. As another example, the token response message may include a flag or other indicator specifying that the message is a token response message.

A “token service provider” may refer to an entity including one or more server computers in a token service system that generates, processes and maintains tokens. The token service provider may include or be in communication with a token vault where the generated tokens are stored. Specifically, the token vault may maintain one-to-one mapping between a token and a primary account number (PAN) represented by the token. The token service provider may have the ability to set aside licensed BINs as token BINs to issue tokens for the PANs that may be submitted to the token service provider. Various entities of a tokenization ecosystem may assume the roles of the token service provider. For example, payment networks and issuers or their agents may become the token service provider by implementing the token services according to embodiments or aspects of the present disclosure. A token service provider may provide reports or data output to reporting tools regarding approved, pending, or declined token requests, including any assigned token requestor IDs. The token service provider may provide data output related to token-based transactions to reporting tools and applications and present the token and/or PAN as appropriate in the reporting output.

A “token service system” refers to a system that facilitates requesting, generating and/or issuing tokens, as well as maintaining an established mapping of tokens to primary account numbers (PANs) in a repository (e.g., token vault). In some embodiments or aspects, the token service system may establish a token assurance level for a given token to indicate the confidence level of the token to PAN binding. The token service system may support token processing of payment transactions submitted using tokens by de-tokenizing the token to obtain the actual PAN. In various embodiments or aspects, the token service system may include a token requestor and a token service provider interacting with the token requestor. In some embodiments or aspects, a token service system may include a tokenization computer alone, or in combination with other computers such as a transaction processing network computer.

A “token vault” may refer to a repository that maintains established token-to-PAN mappings. According to various embodiments or aspects, the token vault may also maintain other attributes of the token requestor that may be determined at the time of registration and that may be used by the token service provider to apply domain restrictions or other controls during transaction processing. For example, the token vault may maintain one-to-one mapping between a token and an account identifying number represented by the token. The token vault may be a part of the token service system. In some embodiments or aspects, the token vault may be provided as a part of the token service provider. Alternatively, the token vault may be a remote repository accessible by the token service provider. Token vaults, due to the sensitive nature of the data mappings that are stored and managed in them, may be protected by strong underlying physical and logical security.

“Transaction amount” may be the price assessed to the consumer for the transaction. The transaction amount condition may be a threshold value (e.g., all transactions for an amount exceeding $100) or a range (e.g., all transactions in the range of $25-$50). For example, a user may wish to use a first routing priority list for a transaction for an amount in the range of $0.01-$100 and a second routing priority list for a transaction for an amount exceeding $100.

“Transaction data” may include any data associated with one or more transactions. In some embodiments or aspects, the transaction data may merely include an account identifier (e.g., a PAN) or payment token. Alternatively, in other embodiments or aspects, the transaction data may include any information generated, stored, or associated with a merchant, consumer, account, or any other related information to a transaction. For example, transaction data may include data in an authorization request message that is generated in response to a payment transaction being initiated by a consumer with a merchant. Alternatively, transaction data may include information associated with one or more transactions that have been previously processed and the transaction information has been stored on a merchant database or other merchant computer. The transaction data may include an account identifier associated with the payment instrument used to initiate the transaction, consumer personal information, products or services purchased, or any other information that may be relevant or suitable for transaction processing. Additionally, the transaction information may include a payment token or other tokenized or masked account identifier substitute that may be used to complete a transaction and protect the underlying account information of the consumer.

A “transaction service provider” may refer to an entity that receives transaction authorization requests from merchants or other entities and provides guarantees of payment, in some cases through an agreement between the transaction service provider and an issuer. For example, a transaction service provider may include a payment network, such as Visa®, MasterCard®, American Express®, or any other entity that processes transactions. As used herein “transaction service provider system” may refer to one or more systems operated by or operated on behalf of a transaction service provider, such as a transaction service provider system executing one or more software applications associated with the transaction service provider. In some non-limiting embodiments or aspects, a transaction processing system may include one or more server computers with one or more processors and, in some non-limiting embodiments or aspects, may be operated by or on behalf of a transaction service provider.

A “user” may include an individual. In some embodiments or aspects, a user may be associated with one or more personal accounts and/or mobile devices. The user may also be referred to as a cardholder, account holder, or consumer.

A “user device” is an electronic device that may be transported and/or operated by a user. A user device may provide remote communication capabilities to a network. The user device may be configured to transmit and receive data or communications to and from other devices. In some embodiments or aspects, the user device may be portable. Examples of user devices may include mobile phones (e.g., smart phones, cellular phones, etc.), PDAs, portable media players, wearable electronic devices (e.g., smart watches, fitness bands, ankle bracelets, rings, earrings, etc.), electronic reader devices, and portable computing devices (e.g., laptops, netbooks, ultrabooks, etc.). Examples of user devices may also include automobiles with remote communication capabilities.

“User information” may include any information that is associated with a user. For example, the user information may include a device identifier of a device that the user owns or operates and/or account credentials of an account that the user holds. A device identifier may include a unique identifier assigned to a user device that can later be used to verify the user device. In some embodiments or aspects, the device identifier may include a device fingerprint. The device fingerprint may an aggregation of device attributes. The device fingerprint may be generated by a software development kit (SDK) provided on the user device using, for example, a unique identifier assigned by the operating system, an International Mobile Station Equipment Identity (IMEI) number, operating system (OS) version, plug-in version, and the like.

In today's world, unauthorized use of personal data raises certain concerns from both ethical and privacy standpoints. Personal data may include for, example, account credentials, account number, payment credential, contact information, account data, account identifier, account token, credentials, a PAN, transaction amount, transaction data, and/or user information. In one example, the personal data may include a user's or a consumer's contact information. Such contact information may include, without limitation, a client device identification, an email address, a street address, and/or an IP address. Client device identification may include the user's or consumer's telephone number where he or she may receive telephone calls, short messaging service (SMS) texts, multimedia messaging service (MMS) texts, and the like. Negative experiences giving rise to ethical and/or privacy issues include the user or consumer receiving random calls or text messages for donations, loans, property purchases, insurance, among other solicitations. This leads to the question of how a third party may have obtained the user's/consumer's contact information and compromised their privacy. Such breaches of customer data are quite recurrent and organizations are increasingly under pressure to protect such customer data and ensure to use it responsibly.

The present disclosure provides various systems and methods to secure personal data through token based abstraction, for example. Systems and methods according to one aspect of the present disclosure may be employed to reduce the number of spam communications customers and identify the source of a data breach. In one aspect, a user initiates a token request for a merchant he/she visits. A unique and randomized token is generated by a token generator application. The user provides the generated token to the merchant. The unique token is mapped to the user's contact information and the merchant ID and is stored in a service provider database. The merchant can use the generated token to send promotional information or billing details to the user by way of calls, SMS texts, MMS texts, emails, street address or PO Box mailers, web site communications. The service provider validates the merchant ID and the token and, if valid, routes the merchant ID and the token to the user's contact information (e.g., client device identification, phone number, email address, street address, IP address, and the like). If the merchant attempts to share or sell the token to another merchant, the service provider will block communications using the user's contact information (e.g., calls, SMS texts, MMS texts, emails, mail delivered to a street address or a PO Box, web site communications, and the like) from the merchant as the token is not mapped to this other merchant. The service provider is now able pinpoint where the data breach occurred and issue a warning to the merchants and the user and can block such communications multiple instances of data breaches are discovered.

Systems and methods according to one aspect of the present disclosure include a data tracking mechanism to identify the apex of organizations causing data leaks and data breaches. In one aspect, a user gives out a randomly generated token to a merchant instead of their contact information (e.g., client device identification, phone number, email address, street address, IP address, and the like). The user receives a token that is randomly generated (e.g., by a payment network such as Visa), using an application running on a client device, for each merchant outlet. The token is mapped to the user's contact information and a unique merchant ID, and the combination of the user's contact information and merchant ID is stored in a service provider database. Whenever a customer visits a store he/she provides a token instead of their contact information. The token is entered in the merchant interface and is used by the merchant to send promotional information to the customer using the customer contact information (e.g., calls, SMS texts, MMS texts, emails, street address or PO box mailers, web site communications, and the like) routed by the service provider. In the event the original merchant passes the token to another merchant, and the other merchant attempts to contact the customer using the customer contact information (e.g., calls, SMS texts, MMS texts, emails, mail delivered to a street address or a PO box, web site communications, and the like) using the token generated for the original merchant, the service provider will block the attempted communication. This will reduce or stop unwanted spam communications to the customer and the data can be utilized to pinpoint data breaches. The service provider can provide a data breach warning to both merchants and if the communication attempts to the customer's contact information persist not after the warning, the service provider can add either on or both the original merchant and the other merchant a block list.

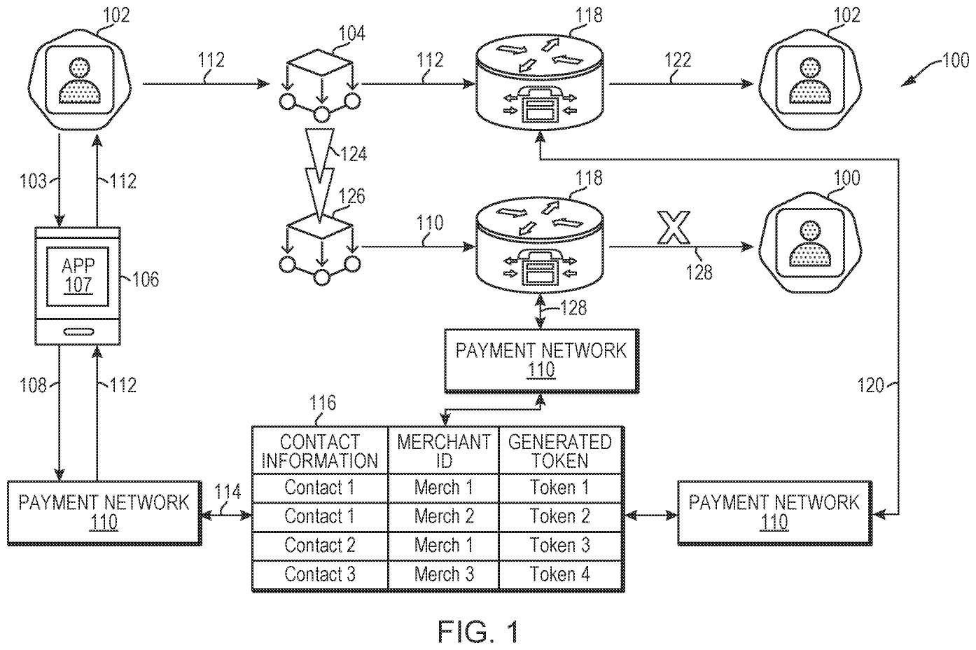

FIG. 1 illustrates a data tracker system 100, according to an aspect of this disclosure. A user 102 initiates 103 a token request 108 for a merchant 104 he/she visits using an application 107 running on a client device 106. The token request 108 is routed to a payment network 110 (e.g., VISA), which generates 114 a token 112 and updates the token 112 in a database 116. The token 112 is mapped to the contact information of the user, which can be the account holder, and a merchant identifier (ID). The merchant identifier may comprises a merchant category code (MCC) as described above. As shown in the database 116, a first user contact information (Contact 1) is mapped to a first merchant (Merch 1) associated with a first token (Token 1). The first user contact information (Contact 1) also can be mapped to a second merchant (Merch 2) associated with a second token (Token 2). A second user contact information (Contact 2) also can be mapped to the first merchant (Merch 1) associated with a third token (Token 3). A third user contact information (Contact 3) can be mapped to a third merchant (Merch 3) associated with a fourth token (Token 4). The merchant 104 may comprise an acceptance device to accept or initiate a transaction with the user 102, the client device 106, and/or the application 107 running on the client device 106. The merchant 104 may provide a merchant application to the user 102. The client device 106 may be an access device or a payment device as described above. In one aspect, the user contact information may be account holder information. In one aspect, the application 107 may be an issuer application, a digital wallet, mobile wallet, and/or an electronic wallet issued by an issuing bank or third party provider. In one aspect, the user 102 may be and end-user. In one aspect, the application 107 may be an application programming interface (API) or may be referred to simply as an interface. In one aspect, the user 102 may initiate 103 the token request 108 during an online purchase.

The generated token 112 is then displayed on the application 107, and can be provided to the merchant 104. The merchant 104 can use the generated token 112 to send the user 102 a communication, which may comprise promotional information in the form of SMSs, calls, or billing details, through a network service provider 118 using the user's 102 contact information 122. The user contact information comprises, for example, land or mobile telephone number, email address, street address, PO Box, web server, and the like. Communications includes telephone calls, SMS texts, MMS texts, multimedia objects, emails, mail delivered to a street address or a PO Box, communications to a web site communications, and the like. The network service provider 118 validates 120 the merchant 102 ID and the token 112 through the payment network 110 based on the user contact information. If the merchant 102 ID and the token 112 are valid, the network service provider 118 routes the communication using the contact information 122 of the account holder, for example, the user's 102 telephone number. In other aspects, communications with the account holder via email address, street address, PO Box, web server, and the like. In other aspects, the user contact information may comprise account credentials, an account number, a payment credential, account data, an account identifier, an account token, and the like. An identification and verification (ID&V) method may be used to ensure that the token 112 is replacing a PAN that was legitimately being used by the token requestor or user 102.

In case the original merchant 104 shares or sells the token 112 to another merchant 126, the network service provider 118 will block communications (e.g., calls/SMSs) from the other merchant 126 because in the database 116 the token 112 is mapped to the original merchant 104 but the token 112 is not mapped to the other merchant 126 who bought or otherwise obtained the token 112 from the original merchant 104. The network service provider 118 can now pinpoint where the data breach has occurred and issue a warning to both merchants 104, 126 and will be blocked if multiple such instances are found.

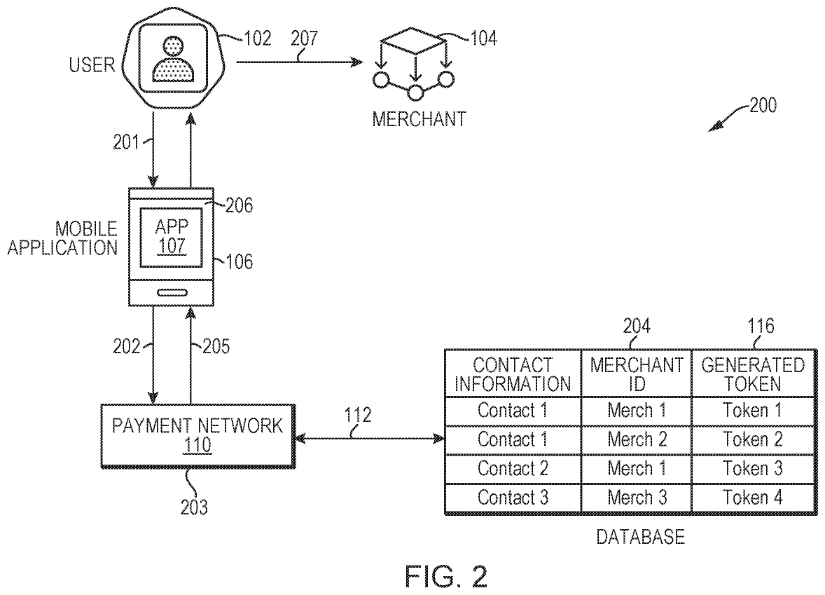

FIG. 2 illustrates a method 200 for provisioning a token in the data tracker system described in reference to FIG. 1, according to an aspect of this disclosure. With reference now to FIG. 2 together with FIG. 1, according to the method 200, the token request 202 is routed to the payment network 110 via an application 107 running on a client device 106. The payment network 110 internally generates a token 112. In one aspect, the token may randomized. This token 112 is stored 204 in a database 116 maintained by the payment network 110. The database 116 stores the user's 102 contact information (e.g., client device identification, phone number, email address, street address, IP address, and the like), a merchant ID that is unique to the merchant 104, and the generated token 112. The generated token 112 is sent 205 to the application 107 and is displayed 206 for the user 102 on the client device 106. The user 102 then sends 207 the token 112 to the merchant 104 instead of sending his/her user contact information. The user 102 sends 207 the token 112 over a communication channel as described above.

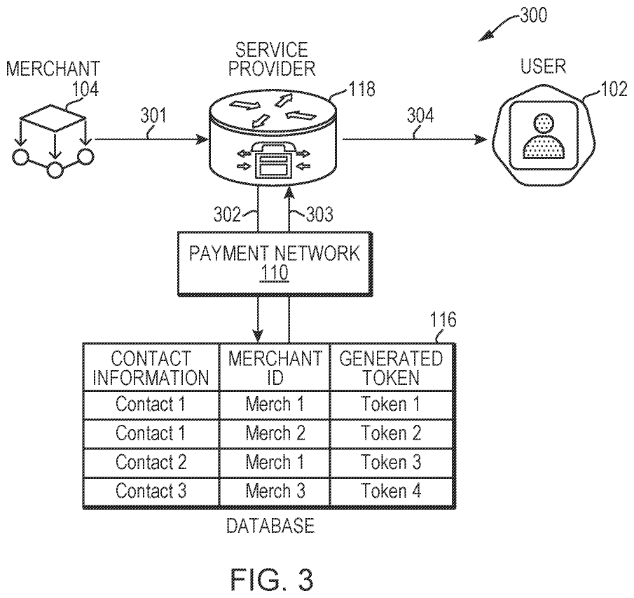

FIG. 3 illustrates a method 300 of a successful merchant to user communication using a token in the data tracker system 100 described in reference to FIG. 1, according to an aspect of this disclosure. With reference now to FIG. 3 together with FIGS. 1 and 2, after the user 102 sends 207 the token 112 to the merchant 104 instead of sending his/her contact information (as shown in FIG. 2), the merchant 104 may want to use the token 112 to contact the user 102 using the user's 102 contact information (e.g., via calls, SMS texts, MMS texts, multimedia objects, emails, mail delivered to a street address or a PO box, web site communications, and the like) regarding promotional offers. A promotional offer may refer to a specific proposition to the user 102 that specifies a reward and user 102 behavioral criteria for earning a reward. The recognition and issue of the reward may be captured through a retail transaction, customer order, rebate claim, rebate redemption, or other user 102 interaction with the merchant 104 that includes a token 112. The merchant 104 sends 301 a request to the network service provider 118. The network service provider 118 receives the merchant identifier (Merch 1) and the token 112 (Token 1) and sends 302 the merchant identifier (Merch 1) and the token 112 (Token 1) to the payment network 110. The (Merch 1) and the token 112 (Token 1), which are stored in the database 116 maintained by the payment network 110, are mapped to the user's 102 contact information (Contact 1) stored in the database 116. The mapping may be performed by the network service provider 118 or the payment network 110, or in a combination of the network service provider 118 or the payment network 110. If the merchant identifier (Merch 1) and the token 112 (Token 1) are mapped to the user's 102 contact information (Contact 1) stored in the database 116, the payment network 110 sends 303 the user's 102 contact information (Contact 1) to the network service provider 118. Using the user's 102 contact information (Contact 1), the network service provider 118 connects the merchant 104 and the user 102. In one example, the user's 102 contact information (Contact 1) stored in the database 116 is the user's 102 client device 106 phone number. Using the user's 102 client device 106 phone number, the network service provider 118 connects 304 the merchant 104 and the user 102.

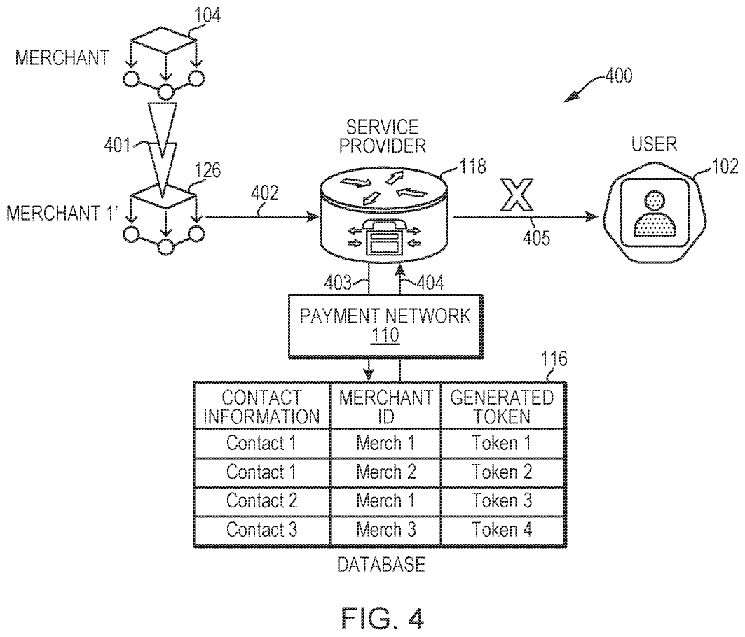

FIG. 4 illustrates a method 400 of a failed third party merchant to user communication using a token in the data tracker system 100 described in reference to FIG. 1, according to an aspect of this disclosure. FIG. 4 will now be described in conjunction with FIGS. 1-3. In one scenario, the original merchant 104 may sell the user's 102 data which includes the token 112 to another merchant 126 (e.g., third party merchant). In another scenario, the original merchant's 104 data may be breached by a security incident that results in unauthorized access to confidential information including the token 112 held by the original merchant 104. In either of the above scenarios, the merchant 126 obtains 401 the user's 102 token 112, which is associated with the original merchant 102. After obtaining the token 112, the merchant 126 attempts the send 402 promotional information to the user 102 using the obtained token 112. The network service provider 118 receives the communication request from the merchant 126 including the third party merchant identifier and the token 112 data. The network service provider 118 queries 403 the payment network 110 maintained database 116 and attempts to find a mapping between the merchant 126 identifier received by the network service provider and the token 112 data. Since the merchant 126 identifier is different from the original merchant 104 identifier, the token 112 and the merchant 126 identifier do not get mapped. The actual third party merchant 126 identifier corresponding to the sent token 112 is noted by the payment network 110 or the network service provider 118 is flagged and the payment network 110 notifies 404 for a potential data breach. Since there is no actual user 102 contact information, the communication will not get routed to the user 102, and the user 102 will be spared unwanted communications from the merchant 126 who obtained the token 112 under questionable circumstances or using questionable means. Potential benefits of the above method 400 include drastically reducing spam communications to the user 102 and identifying the source of a data breach.

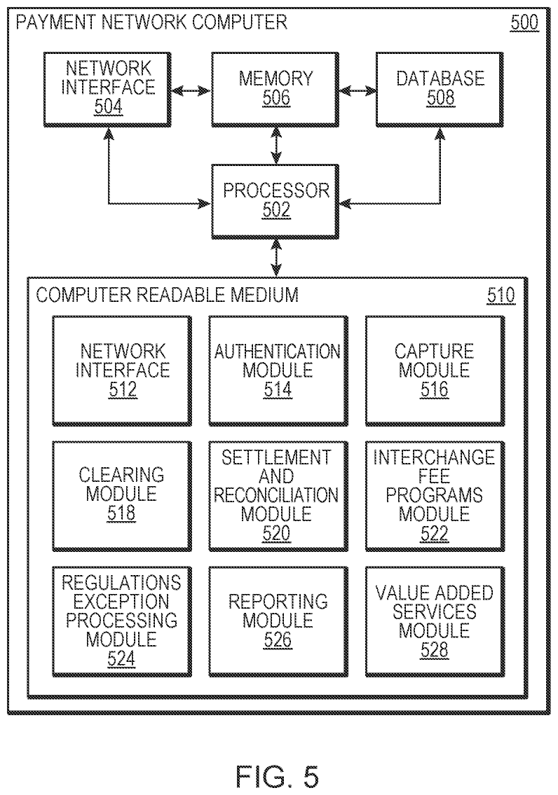

The methods described above in connections with FIGS. 1-4 may be implemented in the computer environments described in reference to FIGS. 5-9.

FIG. 5 shows a block diagram of a payment network computer 500, according to at least one aspect of the present disclosure. FIG. 5 illustrates components of the payment network computer 500, according to at least one aspect of the present disclosure. In some aspects, the payment network 110 shown in FIGS. 1-4 may be implemented using the payment network computer 500 or may be implemented in a similar manner as the payment network computer 500.

The payment network computer 500 may include a processor 502 communicatively coupled to a network interface 504, a memory 506, a database 508, and a computer readable medium 510.

The network interface 504 may be configured to allow the payment network computer 500 to communicate with other entities such as the database 116 and the network service provider 118, an acquirer computer, a different payment processing network, an issuer computer, etc. using one or more communications networks.

The memory 506 may be used to store data. The memory 506 may be coupled to the processor 502 internally or externally (e.g., cloud based data storage) and may comprise any combination of volatile and/or non-volatile memory, for example, RAM, DRAM, ROM, flash, or any other suitable memory device.

The database 508 may store data associated with a plurality of consumers such as consumer personal and payment account information.

The computer readable medium 510 may be in the form of a memory (e.g., flash, ROM, etc.) and may comprise code, executable by the processor 502 for implementing methods described herein. The computer readable medium 510 may include an authorization module 512, an authentication module 514, a capture module 516, a clearing module 518, a settlement and reconciliation module 520, an interchange fee programs module 522, a regulations and/reporting module 526, and a value added services module 528.

The authorization module 512 may comprise code, executable by the processor 502 to validate token data elements, to provide a token assurance level, to provide support for lost and stolen devices and for token exchange.

The authorization module 512 may also comprise code, executable by the processor 502, to process an authorization request message comprising a token. In one aspect, the authorization module 512, in conjunction with the processor 502, may validate the token requestor identifier to determine if the transaction can be approved or declined. For example, the token requestor identifier may be associated with a wallet application that may be used by a consumer to initiate a transaction using a consumer device. The token requestor identifier may be provided by the network token system to a wallet application during the onboarding process. In some aspects, the authorization module 512 may approve or decline the transaction using various data associated with the transaction such as a token presentment mode, token number, token timestamp, token expiration date, token assurance level, a determination that the account used to conduct the transaction is lost, stolen, or compromised, or any other suitable data. The aforementioned data may be determined from the contents of the authorization request message for a transaction, a token registry database, or any other suitable source.

In one aspect, the authorization module 512, working in conjunction with the processor 502, may provide support for token exchange. For example, the authorization module 512 may modify the authorization request message to replace the token with a PAN and send the modified authorization request message to an issuer. The authorization module 512 may also restore the token in the authorization response message received from the issuer before forwarding it to an acquirer computer. In some aspects, records of the authorization may be contained in an authorization log database that can be transmitted to the participating acquirers. The data contained in the authorization log database can be in a plurality of file formats.

In some aspects, the authorization module 512 may be configured to process payment transactions that use a token associated with a different payment network. For example, in some aspects, the authorization module 512 may be configured to generate and send a token verification request to a payment network associated with the token, or specifically to a network token system associated with a payment network. The authorization module 512 may be further configured to receive a token verification response including the original PAN associated with the token and a validation result. The issuer associated with the original PAN may be determined, and an authorization request message for the transaction including the original PAN and the validation result may be sent to the issuer computer.

The authentication module 514 may comprise code that can be executed to the processor 502 to apply one or more authentication methods to authenticate token transactions based on the presentment modes. In one aspect, the authentication module 514 may comprise code for authenticating the QR™ code token transactions using existing authentication schemes (e.g., entering personal information into a keypad). In another example, the authentication module 514 may comprise code for authenticating contactless EMV token transactions based on dCVVs that are formed with our without ATCs (Application Transaction Counters) or cryptograms.

The capture module 516 may comprise code for processing a capture file. For example, a merchant computer may send the token requestor identifier in the capture file that is sent to the acquirer computer. The payment network computer 500 can convert the token into a PAN and provide the PAN to the acquirer computer in the capture file to prepare clearing drafts pursuant to existing processing rules.

The clearing module 518 may be configured to process clearing transactions with tokens. A clearing process may be performed to reconcile orders among the transacting entities such as the issuer computer and the acquirer computer/merchant computer. When a token is used in a clearing draft message, a token requestor identifier may be present in the appropriate data field. In one aspect, for Base II processing, the clearing module 518 can substitute clearing draft messages received with a token with the PAN for related clearing processing. In some aspects, if the authorization was conducted with a token, the token is replaced with a PAN in the authorization data files provided to the acquirer computer. The token number and expiration date can be processed pursuant to existing rules and can be provided in the clearing draft message (e.g., in the expiration date field).

In some aspects, the clearing draft message may include a token assurance level. In one aspect, at the time of transaction processing, if the token requestor identifier is present, the token can be validated against the token requestor identifier to which the token was originally issued. If the validation fails, the payment processing network computer may return an appropriate code in the clearing draft message. In some aspects, based on the issuer option of receiving the token requestor identifier, the payment processing network computer may forward the token requestor identifier in the clearing draft message to the issuer computer. In some aspects, the acquirer computer may retain and return the token requestor identifier value used in the original transaction in all the subsequent transactions. In one aspect, the POS condition code and the POS entry mode code fields can reflect the applicable token presentment mode in the clearing draft message.

The settlement and reconciliation module 520 may be configured to process settlement and reconciliation transactions with tokens. The settlement and reconciliation module 520 may provide support for the token requestor identifier and its validation in the reports and raw data files associated with the settlement and reconciliation processing of the transactions. In one aspect, the settlement and reconciliation module 520 may include the tokens and the token requestor identifier in the reports and raw data files destined to the acquirer computer. In one aspect, the settlement and reconciliation module 520 may include the real PAN and optionally the token requestor identifier in the reports and raw data files destined to the issuer computer. In some aspects, the interface for processing transaction files (e.g., edit package) may be enhanced to process tokens in place of the PANs.

The interchange fee programs module 522 may comprise code for determining interchange rates and fees for token based transactions. Payment transactions conducted with tokens can qualify for existing fee programs and interchange rates applicable to the respective presentment modes and available card products.

The regulations/exception processing module 524 may be configured to apply operating regulations and perform liability and dispute processing for token payment transactions. Payment transactions with tokens can qualify for existing liability rules applicable to the respective presentment modes and available card products. For example, acquires and issuers can qualify for existing chargeback rules based on the presentment modes. The regulations/exception processing module 524 can map the tokens used in the original transactions to facilitate dispute processing related to chargebacks.

The reporting module 526 may be configured to provide reporting for token payment transactions. In some aspects, the reporting module 526 may provide reports for each country and regions based on token attributes such as the token number and token ranges, token requestor identifier, consumer token assurance level, token expiration date, COF (card on file) indicator and the token presentment mode.

The value added services module 528 may comprise code for supporting value added services to support token transactions. For example, account update functions of merchant enquiry and setup of payment controls can be supported for tokens.

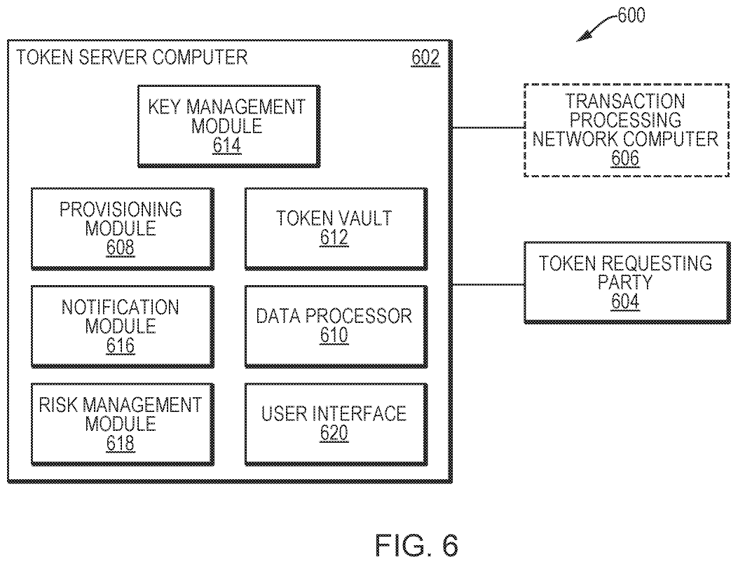

FIG. 6 illustrates a block diagram of a token server computer 600 portion of a token management system, according to at least one aspect of the present disclosure. The token server computer 600 is representative of a tokenization system/environment coupled to the payment network 110 described in connection with FIGS. 1-4. The token server computer 600 generates the token 112. In one aspect, the token 112 is randomized. FIG. 6 illustrates an example tokenization environment implemented as a token server computer 600 including a token server computer 602 of a token service provider. The token server computer 602 may be in communication with a token requesting party 604, such as for, example, the user 102 with the application running on the client device 106. The token requesting party 604 may operate a token requesting party computer. In some aspects, the token server computer 602 also may be in communication with a transaction processing network computer 606 such as, for example, a payment network. In other aspects, the token server computer 602 may be part of the payment network. In various aspects, the token server computer 602 is in communication with a payment network token gateway server computer.

The token server computer 602 may be responsible for provisioning a token using a provisioning module 608 in conjunction with a data processor 610. Provisioning may include creating a token within a token vault 612 for an account, sending the token to the token requesting party 604 and sending the token to the token recipient.

According to aspects directed to payment transactions, the token requesting party 604 may be an account holder, a payment processing network, an issuer, an acquirer and/or a merchant. Aspects discussed below are directed to the token requesting party 604 being an issuer or a third party acting on behalf of the issuer. Aspects of the invention, however, are not restricted to a token requestor that is an issuer.

In some aspects, the token requesting party 604 may register with the token server computer 602 using an online portal or a website of the token server computer 602. The online portal or the website may provide a user interface 620 to allow the token requesting party 604 to interact with the token server computer 602 to control the token generation process.

Using the user interface 620, the token requesting party 604 may request the token server computer 602 to generate one or more tokens for a plurality of accounts issued, owned and/or managed by the token requesting party 604.

The token requesting party 604 (e.g. a computer operated by the token requesting party 604) may provide a set of account identifiers to the token server computer 602. The token server computer 602 may generate (or determine) a token for the account identifier received from the computer operated by the token requesting party 604. The generated tokens may be stored at a token vault 612. The token vault 612 also may store a mapping between each token and the account identifier identifying the account represented by the token. The token vault 612 also may be used by the transaction processing network computer 606 to de-tokenize the token and convert the token to the account number represented by the token when a transaction authorization is processed through the transaction processing network computer 606. The token vault 612 also may manage all domain restrictions associated with each token provisioned.

The token requesting party 604 also may select, with the data processor 610 executing a key management module 614 of the token server computer 602, an option associated with encryption keys. For example, the token requesting party 604 may choose to provide the encryption keys to the token server computer 602 via the key management module 614. In some aspects, the token requesting party 604 may choose to leave the key generation to the token server computer 602. The token server computer 602 may generate (or determine) the tokens based on the option associated with the encryption keys. The token server computer 602 may generate a token associated with at least one encryption key for each account identifier of the set of account identifiers. The token server computer 602 may store the encryption keys along with the associated tokens in the token vault 612. The encryption keys may then be provided to a user device of the account holder. The tokens and corresponding encryption keys may be used in tokenized transactions processed by the transaction processing network computer.

The token requesting party 604 also may initiate a request to receive a message when a token has been generated and/or provisioned for one of the accounts associated with the token requesting party 604. The token server computer 602 may generate a notification using the data processor 610 executing code in the notification module 616 based on the notification criteria (e.g., when a token satisfies the notification criteria) provided by the token requesting party 604. It also may send the notification to the token requesting party 604. For example, the token requesting party 604 may request a notification when a token is generated. The notification module 616 of the token server computer 602 may generate and send a notification to the token requesting party 604 when the token is generated. Similarly, the token requesting party 604 may request a notification when a token is provisioned on a user device. The notification module 616 of the token server computer 602 may generate and send a notification to the token requesting party 604 when the token is provisioned on the user device. For example, the notification module 616 may be informed by the provisioning module 608 that the token has been provisioned.

The token server computer 602 also may include a risk management module 618 that can work in conjunction with the data processor 610 to set up rules for risk decisioning when the token server computer 602 receives the token provisioning request from the token requesting party 604. As part of further customization of the token generation process, the token requesting party 604 may indicate rules for provisioning or processing the token based on a risk assessment associated with a transacting party, a device used in the transaction, or the account itself. In some aspects, the token requesting party 604 may provide a restriction that is placed on one or more of the generated tokens based on the risk decision making rules.

The token server computer 602 shown in FIG. 6 is provided for illustration purposes and should not be construed as limiting. The token server computer 602 may include more or less components than those illustrated in FIG. 6. For example, the token server computer 602 may include additional software modules, such as a processing module, a lifecycle management module, etc. These and other modules may, in conjunction with the data processor 610, allow the token server computer 602 to perform one or more of the following functions: map an account identifier to a token and store the mapping in the token vault with relevant domain restrictions; provision a token from the token vault to a user device; manage (e.g., delete, suspend, resume, etc.) the token both at the token vault and on the user device; generate encryption keys based on the token requesting party's request; manage encryption keys based on predetermined criteria; process tokenized transactions including performing cryptogram validation, domain restriction checks, and validity checks; and perform post-transaction verification processing to verify that transactions and account updates are conducted on the user device after the transaction is processed by the transaction processing network.

In some aspects, the token server computer 602 may support contactless payment use cases. This includes support for contactless payment methods using a secure element and Host Card Emulation (HCE)-based payment applications.

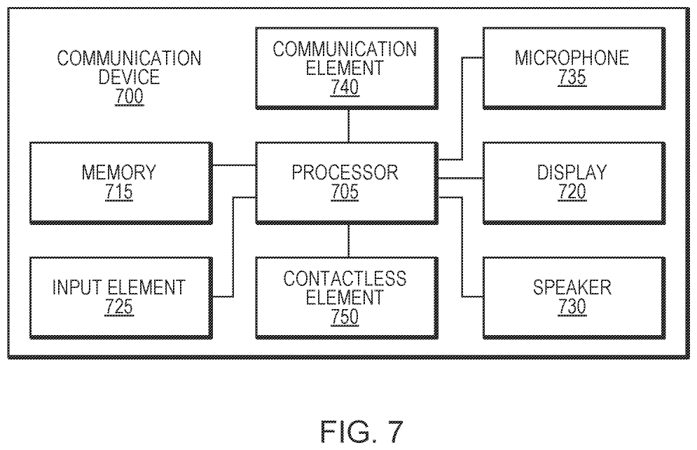

FIG. 7 illustrates a block diagram of a communication device 700 that may be used in aspects, according to at least one aspect of the present disclosure. Accordingly, FIG. 7 illustrates a block diagram of a communication device 700 that may be used in various aspects of the present disclosure. The communication device 700 is representative of the client device 106 described in connection with FIGS. 1-4, and may be a cell phone, a feature phone, a smart phone, a satellite phone, mobile device, or a computing device having a phone capability.

The communication device 700 may include a processor 705 (e.g., a microprocessor or microcontroller) for processing the functions of the communication device 700 and a display 720 to allow a user to see the phone numbers and other information and messages. The communication device 700 further may include an input element 725 to allow a user to input information into the device (e.g., input buttons, touch screen, etc.), a speaker 730 to allow the user to hear voice communication, music, etc., and a microphone 735 to allow the user to transmit his or her voice through the communication device 700. The processor 710 of the communication device 700 may connect to a memory 715. The memory 715 may be in the form of a computer-readable medium that stores data and, optionally, computer-executable instructions.

The communication device 700 also may include a communication element 740 for connection to communication channels (e.g., a cellular telephone network, data transmission network, Wi-Fi network, satellite-phone network, Internet network, Satellite Internet Network, etc.), and in particular, to a server computer and a communication network. The communication element 740 may include an associated wireless transfer element, such as an antenna. The communication element 740 may include a subscriber identity module (SIM) in the form of an integrated circuit that stores an international mobile subscriber identity and the related key used to identify and authenticate a subscriber using the communication device 700. One or more subscriber identity modules may be removable from the communication device 700 or embedded in the communication device 700.

The communication device 700 further may include a contactless element 750, which is typically implemented in the form of a semiconductor chip (or other data storage element) with an associated wireless transfer element, such as an antenna. The contactless element 750 may be associated with (e.g., embedded within) the communication device 700 and data or control instructions transmitted via a cellular network, such as for example, a mobile communication network, and may be applied to the contactless element 750 by means of a contactless element interface (not shown). The contactless element interface may function to permit the exchange of data and/or control instructions between mobile device circuitry (and hence the cellular network) and the contactless element 750.

The contactless element 750 may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth, infra-red, or other data transfer capability that can be used to exchange data between the communication device 700 and an interrogation device. Thus, the communication device 700 may be capable of communicating and transferring data and/or control instructions via both a cellular network and near field communications capability.

The data stored in the memory 715 may include: operation data relating to the operation of the communication device 700, personal data (e.g., name, date of birth, identification number, etc.), financial data (e.g., bank account information, a bank identification number (BIN), credit or debit card number information, account balance information, expiration date, loyalty provider account numbers, tokens, etc.), transit information (e.g., as in a subway or train pass), access information (e.g., as in access badges), etc. A user may transmit this data from the communication device 700 to selected receivers.

The communication device 700 may be, amongst other things, a notification device that can receive alert messages and access reports, a portable merchant device that can be used to transmit control data identifying a discount to be applied, as well as a portable consumer device that can be used to make payments.

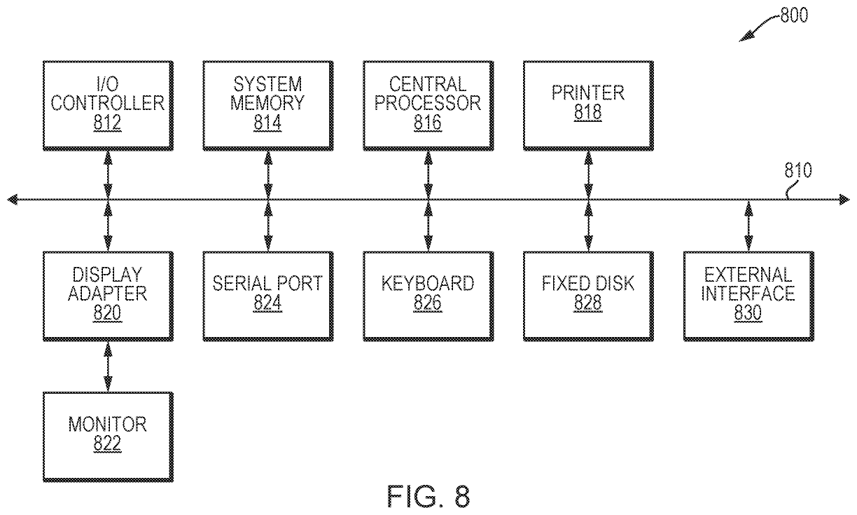

FIG. 8 is a block diagram of a computer apparatus 800 with data processing subsystems or components, according to at least one aspect of the present disclosure. The computer apparatus 800 is representative of any of the computers discussed above. The subsystems shown in FIG. 8 are interconnected via a system bus 810. Additional subsystems such as a printer 818, keyboard 826, fixed disk 828 (or other memory comprising computer readable media), monitor 822, which is coupled to a display adapter 820, and others are shown. Peripherals and input/output (I/O) devices, which couple to an I/O controller 812 (which can be a processor or other suitable controller), can be connected to the computer system by any number of means known in the art, such as a serial port 824. For example, the serial port 824 or external interface 830 can be used to connect the computer apparatus to a wide area network such as the Internet, a mouse input device, or a scanner. The interconnection via system bus allows the central processor 816 to communicate with each subsystem and to control the execution of instructions from system memory 814 or the fixed disk 828, as well as the exchange of information between subsystems. The system memory 814 and/or the fixed disk 828 may embody a computer readable medium.

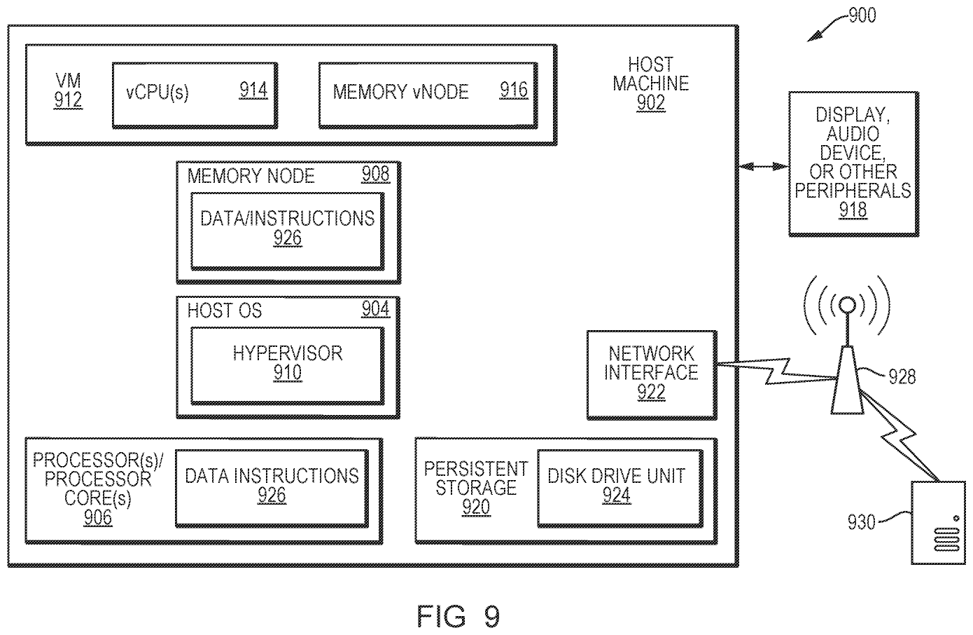

FIG. 9 is a diagrammatic representation of an example computer system 900 that includes a host machine 902 within which a set of instructions to perform any one or more of the methodologies discussed herein may be executed, according to at least one aspect of the present disclosure. The example computer system 900 is representative of any of the computer systems described above. In various aspects, the host machine 902 operates as a standalone device or may be connected (e.g., networked) to other machines. In a networked deployment, the host machine 902 may operate in the capacity of a server or a client machine in a server-client network environment, or as a peer machine in a peer-to-peer (or distributed) network environment. The host machine 902 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes the host machine 902, running a host operating system (OS) 904 on a processor or multiple processor(s)/processor core(s) 906 (e.g., a central processing unit (CPU), a graphics processing unit (GPU), or both), and various memory nodes 908. The host OS 904 may include a hypervisor 910 which is able to control the functions and/or communicate with a virtual machine (“VM”) 912 running on machine readable media. The VM 912 also may include a virtual CPU or vCPU 914. The memory nodes 908 may be linked or pinned to virtual memory nodes or vNodes 916. When the memory node 908 is linked or pinned to a corresponding vNode 916, then data may be mapped directly from the memory nodes 908 to the corresponding vNode 916.

All the various components shown in host machine 902 may be connected with and to each other, or communicate to each other via a bus (not shown) or via other coupling or communication channels or mechanisms. The host machine 902 may further include a video display, audio device or other peripherals 918 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 920 (also referred to as disk drive unit), and a network interface device 922. The host machine 902 may further include a data encryption module (not shown) to encrypt data. The components provided in the host machine 902 are those typically found in computer systems that may be suitable for use with aspects of the present disclosure and are intended to represent a broad category of such computer components that are known in the art. Thus, the example computer 900 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 924 also may be a Solid-state Drive (SSD), a hard disk drive (HDD) or other includes a computer or machine-readable medium on which is stored one or more sets of instructions and data structures (e.g., data/instructions 926) embodying or utilizing any one or more of the methodologies or functions described herein. The data/instructions 926 also may reside, completely or at least partially, within the main memory node 908 and/or within the processor(s) 906 during execution thereof by the host machine 902. The data/instructions 926 may further be transmitted or received over a network 928 via the network interface device 922 utilizing any one of several well-known transfer protocols (e.g., Hyper Text Transfer Protocol (HTTP)).

The processor(s) 906 and memory nodes 908 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 902 and that causes the host machine 902 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 902, with each server 930 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

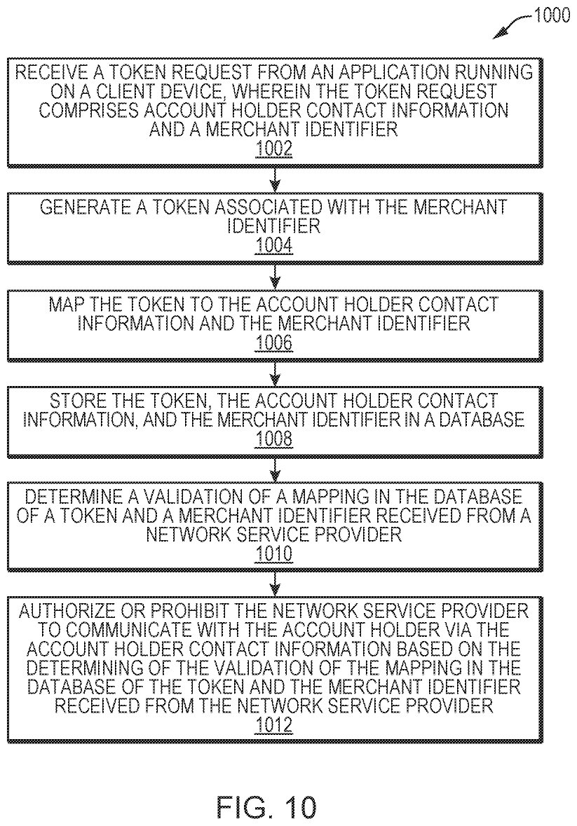

FIG. 10 illustrates a computer-implemented method 1000, according to an aspect of this disclosure. With reference now to FIG. 10 together with FIGS. 1-9, according to the computer-implemented method 1000, the payment network 110 comprises a payment network computer 500 shown in FIG. 5 and a token server computer 600 shown in FIG. 6 as described above. According to the computer-implemented method 1000, the payment network computer 500 receives 1002 a token request 108, 202 from an application 107 running on a client device 106. The token request 108, 202 comprises account holder (e.g., the user 102) contact information and a merchant identifier that identifies the original merchant 104. The token server computer 600 associated with the payment network 110 generates 1004 a token 112 associated with the merchant identifier that identifies the original merchant 104. In one aspect, the payment network computer 500 maps 1006 the token 112 to the user contact information and the merchant identifier. In another aspects, however, the network service provider 118 maps the token 112 to the user contact information and the merchant identifier. The payment network computer 500 stores 1008 the token 112, the user contact information, and the merchant identifier in a database 116 coupled to the payment network computer 500. The payment network computer 500 determines 1010 a validation of a mapping in the database 116 of a token and a merchant identifier received from a network service provider 118. The payment network computer 500 authorizes or prohibits 1012 the network service provider 118 to communicate (e.g., connect) with the account holder via the user contact information based on the determining of the validation of the mapping in the database 116 of the token and the merchant identifier received from the network service provider 118.

In another aspect, according to the computer-implemented method 1000 the payment network computer 500 authorizes the network service provider 118 to communicate (e.g., connect) with the account holder (e.g., the user 102) using the user contact information based on a valid mapping of the token 112 and the merchant identifier received from the network service provider 118.

In another aspect, according to the computer-implemented method 1000 the payment network computer 500 prohibits 405 the network service provider 118 from communicating with the account holder (e.g., the user 102) using the user contact information based on an invalid mapping of the token and the merchant identifier received from the network service provider 118, where the merchant identifier identifies a merchant 126 that is not associated with the token 112 associated with the original merchant 104.

In another aspect, according to the computer-implemented method 1000, the payment network computer 500 determines that a data breach occurred based on the invalid mapping.

In another aspect, according to the computer-implemented method 1000 the payment network computer 500 notifies 404 the network service provider 118 of the data breach.

In another aspect, according to the computer-implemented method 1000, the payment network computer 500 notifies a merchant 104 of the data breach.

In another aspect, according to the computer-implemented method 1000, the payment network computer 500 determines that the token associated with the merchant 126 identified in the token request is not associated with the merchant identifier received from the network service provider 118, where the merchant identifier received from the network service provider 118 identifies the original merchant 104.

In another aspect, according to the computer-implemented method 1000, the payment network computer 500 notifies the original merchant 104 associated with the token 112 of the data breach and notifies the merchant 126 not associated with the token 112 of the data breach.

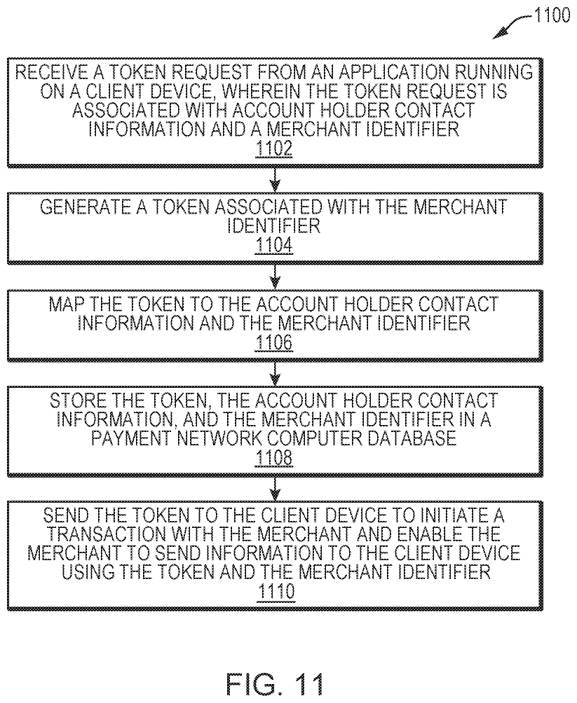

FIG. 11 illustrates a computer-implemented method 1100, according to an aspect of this disclosure. With reference now to FIG. 11 together with FIGS. 1-9, according to the computer-implemented method 1100, the payment network 110 comprises a payment network computer 500 shown in FIG. 5 and a token server computer 600 shown in FIG. 6 as described above. According to the computer-implemented method 1100, according to the computer-implemented method 1100, the payment network computer 500 receives 1102 a token request 108, 202 from an application 107 running on a client device 106. The token request 108, 202 is associated with account holder (e.g., the user 102) contact information and a merchant identifier that identifies the merchant 104. A token server computer 600 associated with the payment network 110 generates 1104 a token 112 based on the token request 108, 202. The payment network computer 500 maps 1106 the token 112 to the user contact information and the merchant identifier. In another aspect, the network service provider 118 maps 1106 the token 112 to the user contact information and the merchant identifier. The payment network computer 500 stores 1108 the token 112, the user contact information, and the merchant identifier in a database 116 coupled to the payment network 110. The payment network computer 500 sends 1110 the token 112 to the client device 106 to initiate a transaction with the merchant 104 and enable the merchant 104 to send information to the client device 106 using the token 112 and the merchant identifier that identifies the merchant 104.

In another aspect, according to the computer-implemented method 1100, the payment network computer 500 receives a validation request from a network service provider 118. The validation request comprises a token and a merchant identifier received by the network service provider 118 from an original merchant 104 or another merchant 126 9e.g., a third party merchant). The payment network computer 500 compares the token and the merchant identifier received from the network service provider 118 with the token mapped to the merchant identifier stored in the database 116.

In another aspect, according to the computer-implemented method 1100, the payment network computer 500 validates a mapping of the token and the merchant identifier received from the network service provider 118. The payment network computer 500 authorizes the network service provider 118 to send 304 a communication to the user contact information mapped to the token 112 and the merchant identifier that identifies the original merchant 104 stored in the database 116.

In another aspect, according to the computer-implemented method 1100, the payment network computer 500 invalidates a mapping of the token 112 and the merchant identifier received from the network service provider 118, where the merchant identifier identifies the merchant 126. The payment network computer 500 prohibits 405 the network service provider 118 to send a communication to the account holder (e.g., the user 102) contact information stored in the database 116.

In another aspect, according to the computer-implemented method 1100, the payment network computer 500 determines that a data breach occurred based on the invalid mapping.

In another aspect, according to the computer-implemented method 1100, the payment network computer 500 notifies the network service provider 118 of the data breach.

In another aspect, according to the computer-implemented method 1100, the payment network computer 500 notifies the original merchant 104 of the data breach.

In another aspect, according to the computer-implemented method 1100, the payment network computer 500 determines that the token associated with the merchant identified in the token request 108, 202 is not associated with the merchant identifier received from the network service provider 118, where the merchant identifier received by the network service provider 118 is associated with the merchant 126.

In another aspect, according to the computer-implemented method 1100, the payment network computer 500 notifies the original merchant 104 associated with the token 112 of the data breach and notifies the merchant 126 not associated with the token 112 of the data breach.

Examples of the devices, systems, and methods disclosed herein, according to various aspects of the present disclosure, are provided below in the following numbered clauses. An aspect of the devices, systems, and methods may include any one or more than one, and any combination of, the numbered clauses described below.

Clause 1. A computer-implemented method, comprising: receiving, by a payment network computer, a token request from an application running on a client device, wherein the token request comprises user contact information and a merchant identifier; generating, by a token server computer, a token associated with the merchant identifier; mapping, by the payment network computer, the token to the user contact information and the merchant identifier; storing, by the payment network computer, the token, the user contact information, and the merchant identifier in a database; determining, by the payment network computer, a validation of a mapping in the database of a token and a merchant identifier received from a network service provider; and authorizing or prohibiting, by the payment network computer, the network service provider to communicate with the account holder via the user contact information based on the determining of the validation of the mapping in the database of the token and the merchant identifier received from the network service provider.

Clause 2. The computer-implemented method of Clause 1, comprising: authorizing, by the payment network computer, the network service provider to communicate with the account holder using the user contact information based on a valid mapping of the token and the merchant identifier received from the network service provider.

Clause 3. The computer-implemented method of any one of Clauses 1-2, comprising: prohibiting, by the payment network computer, the network service provider from communicating with the account holder using the user contact information based on an invalid mapping of the token and the merchant identifier received from the network service provider.

Clause 4. The computer-implemented method of Clause 3, comprising: determining, by the payment network computer, that a data breach occurred based on the invalid mapping.

Clause 5. The computer-implemented method of Clause 4, comprising: notifying, by the payment network computer, the network service provider of the data breach.

Clause 6. The computer-implemented method of Clause 4, comprising: notifying, by the payment network computer, a merchant of the data breach.

Clause 7. The computer-implemented method of Clause 4, comprising: determining, by the payment network computer, that the token associated with the merchant identified in the token request is not associated with the merchant identifier received from the network service provider.

Clause 8. The computer-implemented method of Clause 7, comprising: notifying, by the payment network computer, the merchant associated with the token of the data breach; and notifying, by the payment network computer, the merchant not associated with the token of the data breach.

Clause 9. A computer-implemented method, comprising: receiving, by a payment network computer, a token request from a mobile application running on a client device, wherein the token request is associated with user contact information and a merchant identifier; generating, by a token server computer, a token based on the token request; mapping, by the payment network computer, the token to the user contact information and the merchant identifier; storing, by the payment network computer, the token, the user contact information, and the merchant identifier in a payment network computer database; and sending, by the payment network computer, the token to the client device to initiate a transaction with the merchant and enable the merchant to send information to the client device using the token and the merchant identifier.

Clause 10. The computer-implemented method of Clause 9, comprising: receiving, by the payment network computer, a validation request from a network service provider, the validation request comprising a token and a merchant identifier received by the network service provider from a merchant; and comparing, by the payment network computer, the token and the merchant identifier received from the network service provider with the token mapped to the merchant identifier stored in the payment network computer database.

Clause 11. The computer-implemented method of any one of Clauses 9-10, comprising: validating, by the payment network computer, a mapping of the token and the merchant identifier received from the network service provider; and authorizing, by the payment network computer, the network service provider to send a communication to the user contact information mapped to the token and the merchant identifier stored in the database.

Clause 12. The computer-implemented method of any one of Clauses 9-10 comprising: invalidating, by the payment network computer, a mapping of the token and the merchant identifier received from the network service provider; and prohibiting, by the payment network computer, the network service provider to send a communication to the user contact information stored in the database.

Clause 13. The computer-implemented method of Clause 12, comprising: determining, by the payment network computer, that a data breach occurred based on the invalid mapping.

Clause 14. The computer-implemented method of Clause 12, comprising: notifying, by the payment network computer, the network service provider of the data breach.

Clause 15. The computer-implemented method of Clause 12, comprising: notifying, by the payment network computer, the merchant of the data breach.

Clause 16. The computer-implemented method of Clause 12, comprising: determining, by the payment network computer, that the token associated with the merchant identified in the token request is not associated with the merchant identifier received from the network service provider.

Clause 17. The computer-implemented method of Clause 16, comprising: notifying, by the payment network computer, the merchant associated with the token of the data breach; and notifying, by the payment network computer, the merchant not associated with the token of the data breach.

Clause 18. A data tracker system, comprising: a payment network computer comprising a processor and a memory; a token server computer comprising a processor and memory; a database coupled to the payment network computer, the database storing a mapping of a token, a merchant identifier, and user contact information; wherein the memory of the token server computer stores machine executable instructions that when executed cause the token server computer processor to generate a token associated with a merchant identifier; and wherein the memory of the payment network computer stores machine executable instructions that when executed cause the payment network computer processor to: receive a request for a token associated with the merchant identifier from a client device; map the token, the merchant identifier, and the user contact information; and store the mapping of the token, the merchant identifier, and the user contact information; and determine a validity of the mapping of a token and a merchant identifier received form a network service provider.

Clause 19. The data tracker system of Clause 18, wherein the memory of the payment network computer stores machine executable instructions that when executed cause the payment network computer processor to authorize the network service provider to contact an account holder based on the user contact information stored in the database.

Clause 20. The data tracker system of any one of Clauses 18-19, wherein the memory of the payment network computer stores machine executable instructions that when executed by the payment network computer processor causes the payment network computer processor to prohibit the network service provider to contact an account holder based on the user contact information stored in the database.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer-readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer-readable medium, such as RAM, ROM, a magnetic medium such as a hard-drive or a floppy disk, or an optical medium such as a CD-ROM. Any such computer-readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer-readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A computer-implemented method, comprising:
receiving, by a payment network computer, a token request from an application running on a client device, wherein the token request comprises user contact information and a merchant identifier;
generating, by a token server computer, a token associated with the merchant identifier;
mapping, by the payment network computer, the token to the user contact information and the merchant identifier;
storing, by the payment network computer, the token, the user contact information, and the merchant identifier in a database;
determining, by the payment network computer, a validation of a mapping in the database of a token and a merchant identifier received from a network service provider; and
authorizing or prohibiting, by the payment network computer, the network service provider to communicate with the account holder via the user contact information based on the determining of the validation of the mapping in the database of the token and the merchant identifier received from the network service provider.

2. The computer-implemented method of claim 1, comprising:
authorizing, by the payment network computer, the network service provider to communicate with the account holder using the user contact information based on a valid mapping of the token and the merchant identifier received from the network service provider.

3. The computer-implemented method of claim 1, comprising:
prohibiting, by the payment network computer, the network service provider from communicating with the account holder using the user contact information based on an invalid mapping of the token and the merchant identifier received from the network service provider.

4. The computer-implemented method of claim 3, comprising:
determining, by the payment network computer, that a data breach occurred based on the invalid mapping.

5. The computer-implemented method of claim 4, comprising:
notifying, by the payment network computer, the network service provider of the data breach.

6. The computer-implemented method of claim 4, comprising:
notifying, by the payment network computer, a merchant of the data breach.

7. The computer-implemented method of claim 4, comprising:
determining, by the payment network computer, that the token associated with the merchant identified in the token request is not associated with the merchant identifier received from the network service provider.

8. The computer-implemented method of claim 7, comprising:
notifying, by the payment network computer, the merchant associated with the token of the data breach; and
notifying, by the payment network computer, the merchant not associated with the token of the data breach.

9. A computer-implemented method, comprising:
receiving, by a payment network computer, a token request from a mobile application running on a client device, wherein the token request is associated with user contact information and a merchant identifier;
generating, by a token server computer, a token based on the token request;
mapping, by the payment network computer, the token to the user contact information and the merchant identifier;
storing, by the payment network computer, the token, the user contact information, and the merchant identifier in a payment network computer database; and
sending, by the payment network computer, the token to the client device to initiate a transaction with the merchant and enable the merchant to send information to the client device using the token and the merchant identifier.

10. The computer-implemented method of claim 9, comprising:
receiving, by the payment network computer, a validation request from a network service provider, the validation request comprising a token and a merchant identifier received by the network service provider from a merchant; and
comparing, by the payment network computer, the token and the merchant identifier received from the network service provider with the token mapped to the merchant identifier stored in the payment network computer database.

11. The computer-implemented method of claim 10, comprising:
validating, by the payment network computer, a mapping of the token and the merchant identifier received from the network service provider; and
authorizing, by the payment network computer, the network service provider to send a communication to the user contact information mapped to the token and the merchant identifier stored in the database.

12. The computer-implemented method of claim 10 comprising:
invalidating, by the payment network computer, a mapping of the token and the merchant identifier received from the network service provider; and
prohibiting, by the payment network computer, the network service provider to send a communication to the user contact information stored in the database.

13. The computer-implemented method of claim 12, comprising:
determining, by the payment network computer, that a data breach occurred based on the invalid mapping.

14. The computer-implemented method of claim 12, comprising:
notifying, by the payment network computer, the network service provider of the data breach.

15. The computer-implemented method of claim 12, comprising:
notifying, by the payment network computer, the merchant of the data breach.

16. The computer-implemented method of claim 12, comprising:
determining, by the payment network computer, that the token associated with the merchant identified in the token request is not associated with the merchant identifier received from the network service provider.

17. The computer-implemented method of claim 16, comprising:
notifying, by the payment network computer, the merchant associated with the token of the data breach; and
notifying, by the payment network computer, the merchant not associated with the token of the data breach.

18. A data tracker system, comprising:
a payment network computer comprising a processor and a memory;
a token server computer comprising a processor and memory;
a database coupled to the payment network computer, the database storing a mapping of a token, a merchant identifier, and user contact information;
wherein the memory of the token server computer stores machine executable instructions that when executed cause the token server computer processor to generate a token associated with a merchant identifier; and
wherein the memory of the payment network computer stores machine executable instructions that when executed cause the payment network computer processor to:
receive a request for a token associated with the merchant identifier from a client device;
map the token, the merchant identifier, and the user contact information; and
store the mapping of the token, the merchant identifier, and the user contact information; and
determine a validity of the mapping of a token and a merchant identifier received form a network service provider.

19. The data tracker system of claim 18, wherein the memory of the payment network computer stores machine executable instructions that when executed cause the payment network computer processor to authorize the network service provider to contact an account holder based on the user contact information stored in the database.

20. The data tracker system of claim 18, wherein the memory of the payment network computer stores machine executable instructions that when executed by the payment network computer processor causes the payment network computer processor to prohibit the network service provider to contact an account holder based on the user contact information stored in the database.
